(19) United States
(12) Patent Application Publication
(10) Pub. No.: US 2021/0260495 A1
(43) Pub. Date: Aug. 26, 2021

(54) Animation Reveal Coloring Toy and Puzzle Devices

(71) Applicant: Rufus Butler Seder, Arlington, MA (US)

(72) Inventor: Rufus Butler Seder, Arlington, MA (US)

(21) Appl. No.: 17/181,730

(22) Filed: Feb. 22, 2021

Related U.S. Application Data
(60) Provisional application No. 62/980,415, filed on Feb. 23, 2020.

(51) Int. Cl. A63H 33/22; A63F 9/06; A63F 9/10; G03B 25/02

(52) U.S. Cl. CPC A63H 33/22; G03B 25/02; A63F 9/1044; A63F 9/0613

(57) ABSTRACT

A lenticular animation device for animating coded images. A viewing device has a base structure and a pivotally coupled cover structure. A lenticular plate defines a viewing area, and a manually-operated actuation mechanism, such as a crank system, produces longitudinal, reciprocating relative movement between the platen and the lenticular plate. Lateral edge guides maintain alignment. Corresponding alignment formations retained adjacent to the platen and alignment formations in the coded image member cooperate to maintain alignment of the coded image member. Coded images can include user-completed portions, potentially in combination with non-coded images sharing a unified theme, for being colored by a user. Coded images can be exposed by removing an obscuring overlay or applying a reagent or assembled as puzzle pieces to permit user participation in the creation and animation of coded images. Opposed alignment pegs and holes can lock the cover structure against displacement relative to the base structure.

### RELATED APPLICATION

This application claims priority to Provisional Application No. 62/980,415, filed Feb. 23, 2020, the entirety of which being incorporated herein by reference.

### FIELD OF THE INVENTION

The present invention relates generally to devices for producing a sequential animation of coded images. More particularly, disclosed herein is an animation device wherein coded image members with coded images that are at least partially completed by action of a user are caused to animate by relative movement between the coded image member and a lenticular plate within a viewing device, whether by movement of the lenticular plate, the coded image member, or some other relative movement.

### BACKGROUND OF THE INVENTION

Since the public introduction of the coloring book in the 1880's with the intention of democratizing art, those books have proven to be enduringly popular activity toys with young children, and today with some adults. The pages of such a book are customarily preprinted with black-and-white outlined and partially detailed images of characters or scenes that the user is invited to color in with crayons, colored pencils, markers, and other drawing and painting implements. Little or no artistic skill is required; the user's creative satisfaction is derived from the act of contributing colors to and thus completing the drawings.

In the 1900's, advances in ink chemistry and printing technologies enabled the introduction of what are often referred to as image-reveal drawing books and cards. With colors or even complete images already in place merely to be revealed by the user, even less skill is required than with coloring books. Such books and cards have made a dramatic impact on the craft toy market. Scratch-art technology, for example, permits the user to employ a thin wooden stick or other scraping device to scratch away a concealing, all-black surface to reveal colors or, often, a completely pre-designed, pre-printed, full color image beneath it. Similarly, leuco dye and hydrochromic ink printed pages or cards, which may appear to the eye to be plain white, sometimes with faintly printed outlines, instantly reveal full-colored images and patterns when the user applies special chemical or water-filled markers to their surface.

The ever-popular traditional jigsaw puzzle, which may be considered yet another image-reveal game or toy, also contains predesigned, pre-printed images. The pre-printed images only become apparent once the user assembles the pieces into a whole.

A common thread running through each of these activity toys is that all people, regardless of whether they possess artistic skills or not, can experience a sense of accomplishment and pride from contributing to, indeed completing, a work of art suitable for display.

Lenticular animation is well-known, and a multitude of patents related to such animation have been published over the past century, including by the present inventor, many of them enjoying worldwide success as products. In lenticular animation, the animated effect is created by an optical interaction between a clear lenticular plate and a specially-designed and printed coded image viewed through it.

To appreciate the originality of the present invention's contribution to the art, it will help to review those that came previously. Since the inception of lenticular animation more than one hundred years ago, the most popular has proven to be the lenticular motion card or panel in which a printed coded image is permanently bonded to the back of a lenticular plate. To create an animation effect, the unit is typically held and rocked toward and away from the eye. This rocking, which changes the viewing angle, presents a rapid succession of discreet, yet slightly different, images to the eye. This delivers the impression of a subject or scene in motion, such as an actively galloping horse.

In such devices, the animation effect, while enjoyable, is fleeting because the animating image becomes visually incoherent at extreme angles of tilt after it has completed only two animation cycles. Taking a galloping horse, for example, the horse will only appear to gallop two times clearly, completing only two full, coherent animation cycles, before the card is physically tilted so far that the image becomes visually indistinct. The card must then be tilted back in the opposite direction to cause the same fleeting animation, now reversing its motion, again to appear clear to the eye.

Improvements over the simple animation card have since been developed with the intent of extending the number of animation cycles displayed and improving clarity. In these, the coded image is typically printed on a panel of cardstock rather than being adhered to the back of a lenticular plate, and the panel is slid laterally behind the lenticular plate to deliver animation. In such a device, because no tilting or rocking of the assembly is required, the animating image may be viewed straight on as the card is slid back and forth beneath the plate. This delivers a continuous repetition of animation cycles with clarity as long as the card is made to slide steadily in one direction. Some such devices have been manufactured as permanently sealed units containing only one coded image card. Other devices are designed to enable the user to substitute coded image cards manually to enable varied animations. Usually, to actuate the animation effect, the user is required to cause the card to slide a small distance beneath the fixed lenticular plate by a mechanism or by direct manipulation.

Most devices that permit the user to change cards are designed with a sleeve that has a clear lenticular front into which a coded image card is inserted. To ensure proper x/y alignment of the inserted card relative to the lenticular plate, the card is typically fixed by the user to a sliding carrier within the device. In some devices, such as that of U.S. Pat. No. 6,357,153, a carrier can be spring-loaded and actuated by pressing of the user's finger against one end thereof. In other structures, such as that of U.S. Pat. No. 6,843,009, animation is triggered by the user's manipulation of a mechanically levered hinge system or even a pull tab system.

Typically, the mechanical constructs and demands of such devices create challenges for the user, including relative to swapping out animation cards. In one instance, multiple tabs extending out from the perimeter of the card must first be manually fit into tight slots to ensure accurate x/y registration with the lenticular plate. In others, to remove and replace a card, the disassembly and reassembly of at least one portion of the device itself is necessary. These challenges have hobbled the appeal of such devices to the otherwise vigorous and lucrative children's toy market.

Another problem typical of such devices is that of the two elements: the lenticular plate and the card beneath it. The mechanical design is normally such that it is the lenticular plate that remains fixed in position while the card is made to slide beneath it. While the motion of the sliding card delivers an animation effect, the picture itself sliding back and forth as a whole distracts from the magic of the animation effect while adding nothing to it.

A further problem with such devices is that the manual action required of the user to cause the required sliding is often neither instinctive nor easy. For example, the act of pressing the end of a spring-loaded coded image carrier slowly and steadily enough within such a device to impart a realistic cadence of motion to the animated subject, rather than just an indistinguishable blur, is beyond the capabilities of most children and even, as this inventor has learned, most adults. Pull tabs that extend from the end of the interchangeable coded image cards, intended to permit the user to pull the picture a short distance beneath the lenticular plate manually and slowly enough to achieve a realistically-cadenced animation effect, make almost impossible demands upon the user's motor skills. Although it may be appropriate for a book or a case in which a cover or pages are turned, the mechanically-levered hinge system that successfully transforms the user's manual action of lifting a lever or flap into an acceptably slower, smoother sliding motion is not an instinctive application for a child's toy.

There is thus an apparent need with respect to manually-operated animation devices to enable the conversion of natural and instinctive user motion and the natural speed of user motion into realistically-cadenced animation, animation that appears to obey the laws of physics of the real world. Such an animation device would meet the true goal of ergonomics, namely to refine the design of products to optimize them for human use.

Yet another factor to be considered with such devices is the cost and complexity of manufacture. Lenticular plates must be formed, such as by molding and cutting, and subsequent processing, and manufacture and assembly must be performed in a manner that ensures accurate, known alignment of the lenticles of the lenticular plate in relation to the remainder of the toy, particularly the coded images to be animated. Meanwhile, many factories have little experience and expertise with machining and assembling animation toys that rely on lenticular plates. Accordingly, the present inventor has appreciated that animation devices must accommodate the realities of the manufacturing process if clear, convincing animation is to be convincingly achieved in a reliable, commercially practicable manner.

The above issues and challenges have, until now, prevented the creation and real market adoption of a manually-operated animation device wherein images can be completed by a user and then caused to animate in a clear, accurately-aligned, and realistically-cadenced manner.

### SUMMARY OF THE INVENTION

Appreciating the enjoyment that users could realize through directly participating in the completion and revelation of animating images and the limitations and challenges with the devices of the prior art, the present inventor set forth with the basic object of providing an animation device that permits a user to complete and reveal animated images in an effective and commercially-viable construction.

A related object of the invention is to provide animation reveal coloring toy and puzzle devices that extend the play value and market appeal of such activity toys, including by adding the novel dimension of realistic motion to user-completed images.

Again with an appreciation of the challenges presented by coded image animation devices of the past, the present invention is further founded on the object of providing an instinctive, quick, and fun way for users from young children to adults to bring their own colored-in pictures, image-reveal pictures, and jigsaw puzzles to realistic life in an easily hand-operated mechanical device.

A related object of the invention is to provide a coded image animation device that can be manually actuated through ergonomically-designed mechanics to deliver a realistically-cadenced animation effect that appears to obey the laws of physics of the real world through the natural and instinctive motion of the user.

An additional object of embodiments of the invention is to provide an animation device that facilitates accurate x/y registration between an interchangeable coded image panel and a lenticular plate while promoting full contact between facing surfaces of the coded image panel and the lenticular plate.

These and further objects, advantages, and details of manifestations of the present invention will become obvious not only to one who reviews the present specification and drawings but also to those who have an opportunity to experience an embodiment of the animation reveal coloring toy and puzzle devices disclosed herein in operation. However, it will be appreciated that, although the accomplishment of each of the foregoing objects in a single embodiment of the invention may be possible and indeed preferred, not all embodiments will seek or need to accomplish each and every potential advantage and function. Nonetheless, all such embodiments should be considered within the scope of the present invention.

In carrying forth one or more of the foregoing objects, one embodiment of the present invention comprises a lenticular animation system for animating a coded image of a coded image member. The system can be considered to be founded on a viewing device comprising a base structure with a platen for supporting the coded image member. A cover structure is pivotally coupled to the base structure with a closed position atop the base structure and an open position. A lenticular plate is retained by the cover structure to span and to define a viewing area within the cover structure, and an actuation mechanism is operative to produce relative movement between the platen and the lenticular plate. Under such constructions, animation of a coded image of a coded image member supported by the platen can be perceived within the viewing area when the actuation mechanism produces relative movement between the platen and the lenticular plate.

As disclosed herein, the animation system can further include alignment formations comprising protuberances retained to be disposed adjacent to left and right lateral edges of the platen, whether by the platen itself or by structure adjacent to the platen, and alignment formations are disposed in the coded image member. The alignment formations of the coded image member can, for example, comprise notches for receiving the protuberances. Where the lenticular plate is considered to have left and right lateral edges, the alignment formations comprising protuberances can be disposed laterally outside of the left and right lateral edges of the lenticular plate. The platen has a platen surface disposed in a plane, and the alignment formations retained adjacent to opposed edges of the platen can comprise protuberances that project beyond the plane of the platen surface in a direction generally perpendicular to the plane of the platen surface.

In certain embodiments, the cover structure comprises a framework with left and right frame sections that are disposed atop the lenticular plate when the cover structure is in a closed position. The left and right frame sections can have portions that project laterally beyond the lateral edges of the lenticular plate, and the alignment formations retained adjacent to lateral edges of the platen can be aligned with the portions of the left and right frame sections that project laterally beyond the lateral edges of the lenticular plate. It is still further contemplated that the alignment formations retained adjacent to opposed edges of the platen can have upper edges proximal to the hinge that are slanted to an acute angle toward the hinge. With that, coded image members can be stably retained by engagement between the alignment formations, particularly where the base structure is disposed at an angle for viewing.

According to practices of the invention where the cover structure is pivotally coupled to the base structure by a hinge, an alignment and registration combination can be incorporated for aligning and registering the cover structure relative to the base structure. The alignment and registration combination can, for instance, comprise at least one alignment projection that projects from one of the cover structure and the base structure in combination with at least one receiving formation for receiving the at least one alignment projection with the receiving formation being disposed in the other of the cover structure and the base structure. For example, the at least one alignment projection can take the form of a post, and the at least one receiving formation can incorporate a positive engagement mechanism for receiving and positively engaging the at least one alignment projection. More particularly, the post can terminate in a bulbous end portion, and the positive engagement mechanism can be a spring-loaded, snap-fit, or spring-loaded and snap-fit positive engagement mechanism.

Alternatively or additionally, the system can incorporate an alignment and registration combination for aligning and registering the cover structure relative to the base structure, the alignment and registration combination comprising a first alignment pair spaced from a second alignment pair. Each alignment pair comprises an alignment peg and an alignment hole for receiving the alignment peg. The alignment peg of the first alignment pair projects from the base structure, and the alignment hole of the first alignment pair is disposed in the cover structure. In an opposite manner, the alignment peg of the second alignment pair projects from the cover structure, and the alignment hole of the second alignment pair is disposed in the base structure. The alignment hole of each alignment pair is broader along a receiving direction orthogonal to the hinge axis than a thickness of the alignment peg of the alignment pair along the receiving direction. Each alignment hole can be considered to have a first end proximal to the hinge and a second end distal to the hinge, and the alignment pegs of the first and second alignment pairs are received in immediate proximity to the same of the first or second ends of the respective alignment holes. Stated alternatively, both alignment pegs can be received in proximity to the first ends of the respective alignment holes, or both alignment pegs can be received in proximity to the second ends of the respective alignment holes. Under such embodiments, when the cover structure is pivoted to a closed position, the cover structure is locked against displacement relative to the base structure by contact of the alignment pegs with the ends of the respective alignment holes.

In further practices of the invention, the alignment and registration combination further comprises third and fourth alignment pairs with the alignment peg of the third alignment pair projecting from the base structure, the alignment hole of the third alignment pair disposed in the cover structure, the alignment peg of the fourth alignment pair projecting from the cover structure, and the alignment hole of the fourth alignment pair disposed in the base structure. Again, the alignment holes are broader along a receiving direction orthogonal to the hinge axis than a thickness of the alignment peg along the receiving direction with the alignment pegs of the third and fourth alignment pairs received in immediate proximity to the same of the first or second ends of the respective alignment holes. The first, second, third, and fourth alignment pairs can, for example, be disposed in a rectangular configuration, such as adjacent to the four corners of the cover structure where the cover structure is rectangular.

In certain embodiments, the lenticular plate is retained to slide longitudinally relative to the cover structure, and the actuation mechanism is operative to reciprocate the lenticular plate longitudinally. The lenticular plate has left and right lateral edges, and left and right lateral edge guides retained by the cover structure guide and maintain alignment of the lenticular plate during reciprocation of the lenticular plate in relation to the cover structure. For example, each of the left and right lateral edge guides can comprise a lateral surface disposed lateral to the respective lateral edge of the lenticular plate and an inwardly extending section that overlies the lenticular plate thereby to prevent unintended lateral movement of the lenticular plate but to permit longitudinal reciprocation of the lenticular plate.

In other embodiments, the platen is retained by a carriage structure to slide longitudinally relative to the base structure, and the actuation mechanism is operative to reciprocate the carriage structure and the platen longitudinally. Again, left and right lateral edge guides, now retained by the base structure, guide and maintain alignment of the carriage structure and the platen during reciprocation of the carriage structure relative to the base structure. The actuation mechanism can be operative to produce longitudinal relative reciprocation between the platen and the lenticular plate over a range of reciprocation of a distance equal to a whole multiple of lens pitches.

In practices of the invention, the manually-operated actuation mechanism comprises a crank system with a rotatable hand crank for being rotated by a user and a gearing system for inducing longitudinal reciprocation based on a rotation of the hand crank. To produce naturally-cadenced animation, the gearing system and the lens pitch of the lenticular plate can be calibrated to move the lenticular plate at approximately three lenticles per second when the hand crank is rotated at 1.5 rotations per second so that an instinctive rotation of the hand crank at 1.5 rotations per second will ergonomically convert to a movement of the lenticular plate at approximately three lenticles per second.

In certain practices of the invention, the gearing system comprises a primary gear coaxial with and driven by the hand crank, a secondary gear driven by the primary gear, and an offset actuation member rotated with the secondary gear. It has been found that realistically-cadenced animation can be achieved in such embodiments where the primary gear and the secondary gear have an approximately 115^{th} gear ratio.

According to certain embodiments, the coded image is formed by a plurality of interlaced strips of plural images, and at least a portion of the coded image comprises a user-completed portion for being colored by a user. With that, a user can participate in the creation of coded images for coded image animation by completing the user-completed portion of the coded image for animation by movement of the lenticular plate. Moreover, the coded image member can further include a non-coded image thereon. The coded image and the non-coded image can relate to a unified theme. With that, the theme of the coded image can be perceived by reference to the theme of the non-coded image thereby further enhancing the ability of a user to participate in the creation of coded images.

Where the coded images include user-completed portions for being colored by a user, the plurality of interlaced strips of plural images of the coded image can be outlined except where adjacent interlaced strips of images are in contact. A continuous, user-completed portion is presented where adjacent interlaced strips of images are in contact. Further, the lenticular plate in such embodiments can have lenticles disposed at a resolution between 10 lenses per inch and 20 lenses per inch with the coded image of the coded image member disposed at a resolution matching the resolution of the lenticles of the lenticular plate.

Alternatively or perhaps additionally, a removable obscuring overlay can be disposed atop the coded image. With that, a user can participate in a revelation of the coded image by removing the obscuring overlay to expose the coded image for animation by relative movement between the platen and the lenticular plate.

In still further practices of the invention, the coded image is exposable on exposure of the coded image to a reagent. Accordingly, a user can participate in a revelation of the coded image for animation by relative movement between the platen and the lenticular plate by application of the reagent.

Still further, as disclosed herein, the coded image member can be formed as a jigsaw puzzle of puzzle pieces with the coded image spanning plural puzzle pieces. Under such constructions, a user can participate in a revelation of the coded image by assembling the puzzle pieces to assemble the coded image member for animation by relative movement between the platen and the lenticular plate. In such embodiments, a puzzle platen can include an indentation for receiving and retaining the puzzle pieces. The puzzle platen with the puzzle pieces can be disposed on the platen of the base structure to permit animation. Still more particularly, the puzzle pieces can have a thickness marginally greater than a depth of the indentation of the puzzle platen. With that, the lenticular plate can be disposed in contact with the puzzle pieces when the cover structure is closed over the base structure. Alignment formations in the puzzle platen and alignment formations retained to project from adjacent to the platen can be disposed in correspondence for engagement between the alignment formations when the puzzle platen is supported by the platen.

Embodiments of the invention can alternatively be characterized as a lenticular animation kit for animating a coded image of a coded image member. The animation kit can include a coded image member with a coded image disposed thereon. The coded image is formed by a plurality of interlaced strips of plural images. A viewing device is again founded on a base structure with a platen with a platen surface and left and right lateral edges. The platen surface can support the coded image member. A cover structure is pivotally coupled to the base structure by a hinge to have a closed position atop the base structure and an open position. A lenticular plate is retained by the cover structure to span and to define a viewing area within the cover structure. The lenticular plate has left and right lateral edges and lenticles that communicate laterally between the left and right lateral edges. A manually-operated actuation mechanism is operative to produce longitudinal, reciprocating relative movement between the platen and the lenticular plate. Alignment formations are disposed adjacent to the left and right lateral edges of the platen, and alignment formations are disposed in the coded image member. The alignment formations disposed adjacent to the left and right lateral edges of the platen and the alignment formations of the coded image member are disposed in correspondence for engagement between the alignment formations when the coded image member is supported by the platen. Under such constructions, animation of the coded image of the coded image member can be perceived within the viewing area when the actuation mechanism produces longitudinal, reciprocating relative movement between the platen and the lenticular plate when the coded image member is supported on the platen with the cover structure in the closed position.

One will appreciate that the foregoing discussion broadly outlines the more important goals and features of the invention to enable a better understanding of the detailed description that follows and to instill a better appreciation of the inventor's contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

In the accompanying drawing figures:

FIG. 1A is a perspective view of a viewing device of an animation reveal coloring toy and puzzle device according to the present invention with a coded image member being applied thereto;

FIG. 1B is a perspective view of the animation reveal coloring toy and puzzle device with the coded image member in place on the viewing device;

FIG. 1C is a perspective view of the animation reveal coloring toy and puzzle device with the coded image member in place on the viewing device and the cover structure in a closed position;

FIG. 2A is a view in front elevation of a coded image member as disclosed herein;

FIG. 2B is a view in front elevation of the coded image member of FIG. 2A during completion thereof;

FIG. 2C is a view in front elevation of an animation reveal coloring toy and puzzle device with the completed coded image member of FIGS. 2A and 2B retained for animation;

FIG. 3A is a view in front elevation of another coded image member as disclosed herein;

FIG. 3B is a view in front elevation of the coded image member of FIG. 3A during completion thereof;

FIG. 3C is a view in front elevation of an animation reveal coloring toy and puzzle device with the completed coded image member of FIGS. 3A and 3B retained by the viewing device for animation;

FIG. 4 is a view in front elevation of another coded image member according to the invention during completion thereof;

FIG. 5 is a view in front elevation of a further coded image member during exposure of a coded image thereon;

FIG. 6 is a view in front elevation of still another coded image member during exposure of a coded image thereon;

FIG. 7 is a view in front elevation of an alternative animation reveal coloring toy and puzzle device according to the invention;

FIG. 8A is a perspective view of yet another coded image member according to the invention;

FIG. 8B is a perspective view of the coded image member of FIG. 8A completed;

FIG. 8C is a perspective view of an animation reveal coloring toy and puzzle device with the completed coded image member of FIGS. 8A and 8B retained by the viewing device for animation;

FIG. 9 is a view in front elevation of an animation reveal coloring toy and puzzle device according to the invention with the viewing device retaining a coded image member;

FIG. 10 is an amplified view in front elevation of a crank system portion of an alternative viewing device according to the invention;

FIG. 11 is a perspective view of a fitting member for the crank system of the viewing device of FIG. 10;

FIG. 12 is a view in front elevation of a crank system of an embodiment of the viewing device;

FIG. 13 is a view in front elevation of an alternative crank system of an embodiment of the viewing device;

FIGS. 14A through 14D are views in front elevation of manifestations of alignment formations according to the invention;

FIGS. 15A through 15C are views in side elevation of viewing devices as disclosed herein with the cover structure progressing from open to closed positions in relation to the base platform;

FIGS. 16A through 16B are perspective views of animation reveal coloring toy and puzzle devices according to the invention with a reversible platen;

FIGS. 17A through 17B are views in front elevation of alternative cover structures for viewing devices according to the invention;

FIG. 18 is a perspective view of a further embodiment of the animation reveal coloring toy and puzzle device disclosed herein;

FIG. 19 is a top plan view of a platen portion of the alternative animation reveal coloring toy and puzzle device of FIG. 18 retaining first, second, and third coded image members;

FIG. 20 is a perspective view of a lenticular plate according to the invention during insertion into a planing sleeve;

FIG. 21 is a perspective view of the animation reveal coloring toy and puzzle device of FIG. 18 with the crank system separated from the carriage;

FIG. 22 is a perspective view of carriage and platen structures according to the invention in sliding engagement with a base structure;

FIG. 23A is a perspective view of a base structure according to the embodiment of FIG. 18;

FIG. 23B is a top plan view of the base structure;

FIG. 24 is a schematic top plan view of an embodiment of the animation reveal coloring toy and puzzle device;

FIG. 25 is a view in side elevation of an embodiment of the animation reveal coloring toy and puzzle device; and

FIG. 26 is a view in side elevation of an alternative embodiment of the animation reveal coloring toy and puzzle device.

### DETAILED DESCRIPTION OF PREFERRED EMBODIMENTS

Animation devices according to the present invention could pursue widely varied embodiments. However, to ensure that one skilled in the art will be able to understand and, in appropriate cases, practice the invention, certain preferred embodiments of the broader invention revealed herein are described below and shown in the accompanying drawing figures. These embodiments are not intended to be limiting.

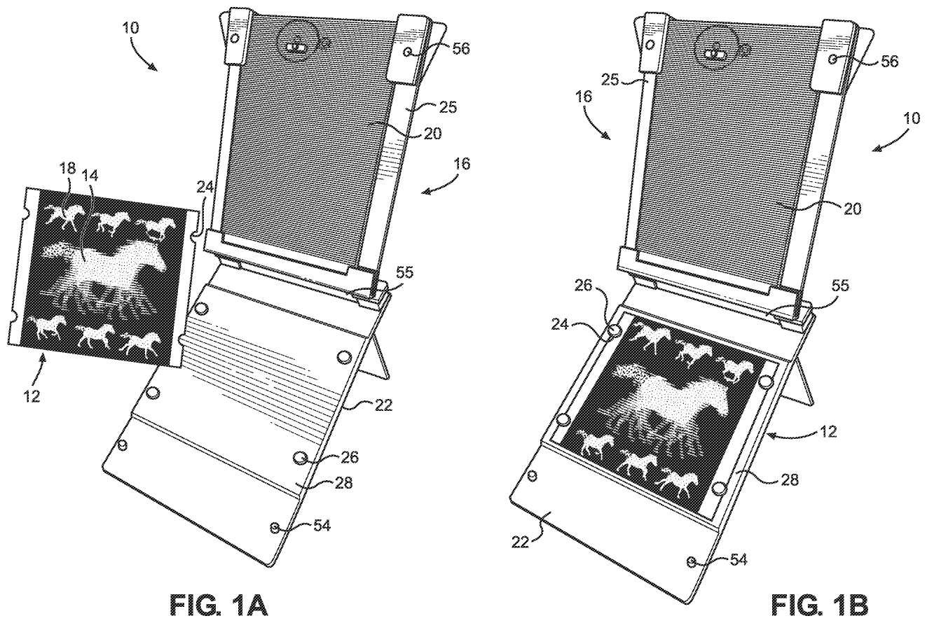

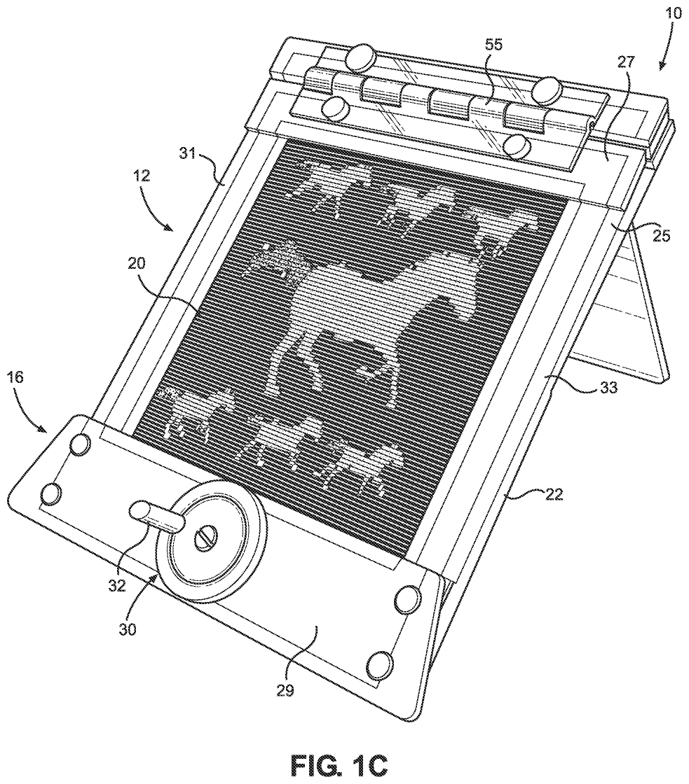

Looking first to FIGS. 1A through 1C, a non-limiting embodiment of an animation reveal coloring toy and puzzle device according to the present invention is indicated generally at 10. The animation device 10, which may alternatively be embodied and referred to as an animation kit, incorporates one or more coded image members 12 bearing one or more pre-printed coded image portions 14 to be colored in, assembled, revealed, or otherwise completed by the user. Coded image members 12 pursuant to the invention could, by way of example and not limitation, be founded on a paper or cardstock card 18, which could be formed unitarily or in pieces, or on some other material.

This embodiment of the animation device 10 further includes a viewing device 16. The illustrated viewing device 16 is a mechanical viewing device and, more particularly, a hand-cranked, mechanical viewing device. As shown in FIG. 1C, for example, the viewing device 16 of the present embodiment has a cover structure 25 that comprises a framework with an upper frame section 27, a lower frame section 29, and left and right lateral frame sections 31 and 33. A viewing opening is defined within the cover structure 25 within the space between the frame sections 27, 29, 31, and 33. A lenticular window or plate 20 is retained to span between the frame sections 27, 29, 31, and 33. The cover structure 25 is hingedly coupled to a base structure 22 in the embodiment of FIGS. 1A through 1C by a hinge structure 55. The base structure 22 may alternatively be referred to as a base platform 22. In the depicted embodiment, the lenticular plate 20 is retained by the cover structure 25 with the left and right frame sections 31 and 33 projecting laterally beyond the lateral edges of the lenticular plate 20 and with the left and right frame sections 31 and 33 atop the lenticular plate 20 when the plate 20 is in a closed position.

Coded image members 12, whether in the form of cards, puzzle pieces, or other members, can include alignment formations, in this example pre-cut notches 24 in their sides, that are shaped and located to engage with corresponding alignment formations 26, which in this example comprise alignment posts or buttons 26 that project from or from a position adjacent to a platen 28 of the base structure 22. When the coded image members 12 are disposed on the base structure 22, the alignment formations 24 of the coded image members 12 engage the alignment formations 26 of the base structure 22 to ensure accurate alignment of the coded images 14 with the lenticles of the lenticular window 20. Under this construction, a coded image member 12 can be colored or otherwise completed, revealed, or exposed and then placed on the viewing device 16 with the alignment formations 24 and 26 aligned and engaged. The cover structure 25 with the lenticular window 20 can then be caused to overlie the coded image member 12, such as by being pivoted to a closed condition as in FIG. 1C.

The viewing device 16 incorporates an actuation mechanism for imparting a relative movement between the lenticular window 20 and a coded image member 12 retained by the viewing device 16. The actuation mechanism could be automatic, such as by motorization, or it could be manual as shown, for example, in relation to the animation device 10 of FIGS. 1A through 1C. There, the actuation mechanism comprises a manually-operated crank system 30 that is operative to reciprocate the lenticular window 20 longitudinally in relation to the remainder of the cover structure 25 and, thus, in relation to a coded image member 12 when the cover structure 25 is closed and the coded image member 12 is retained on the platen 28 of the base structure 22. As such, the crank system 30 is retained by the cover structure 25 as further shown and described herein.

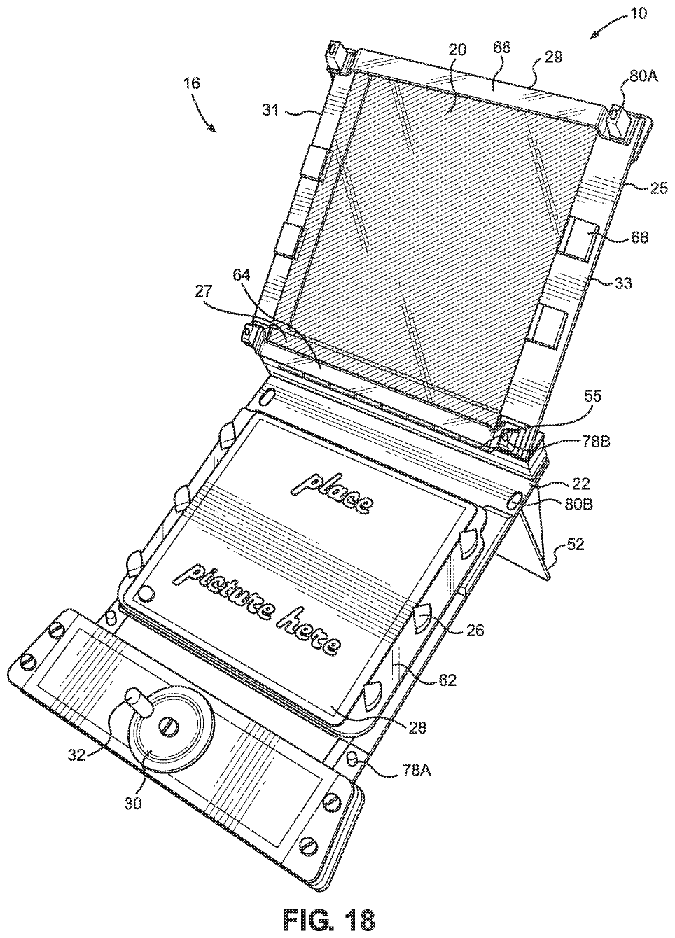

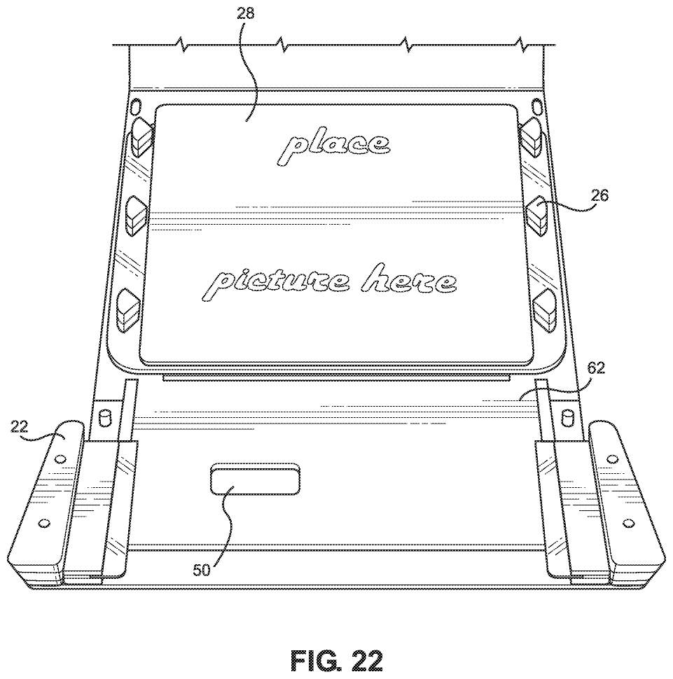

However, as is further shown and described hereinbelow, it is alternatively possible for the lenticular window 20 to remain stationary in relation to the cover structure 25 while the underlying platen 28 is longitudinally reciprocated in relation to the base structure 22 and thus in relation to the cover structure 25 and the lenticular window 20 retained thereby. In such embodiments, as shown in FIGS. 18 through 26 for example, the crank system 30 can be retained by the base structure 22. Advantageously, with the crank system 30 so disposed, the cover structure 25 is rendered lighter and more manageable. Also as discussed herein, longitudinal or up-and-down reciprocation may be preferred for optimal viewer perception of animation, but lateral or left-and-right reciprocation is within the scope of the present invention except as the claims might expressly exclude.

Referring again to the embodiment of FIGS. 1A through 1C, with the coded image member 12 aligned with the lenticular window 20, operation of the actuation mechanism triggers movement of the lenticular window in relation to the coded image member 12, and that relative movement causes the coded images 14 to appear to spring to life and animate realistically. An image of a horse can thus appear to gallop, a spaceship can rotate in place, aliens can be beamed up from the ground, a favorite cartoon character can appear to dance and frolic, and any other animation can be achieved.

The alignment formations 24 and 26, which can comprise aligned notches and buttons, have been found to yield surprisingly accurate registration and to permit quick and easy application of coded image members 12, even by small children. The alignment formations 26 of the base structure 22 in the depicted embodiment are disposed to reside outside of the borders of the lenticular plate 20, not beneath the plate 20, so that the formations 26 permit the back of the lenticular plate 20 to make full contact with the face of the printed coded image 14 on the coded image member 12. Such full contact has been found to be essential to the focal clarity and thus the successful presentation of animation.

In the depicted, non-limiting embodiment of the animation device 10 where the actuation mechanism comprises a crank system 30, the crank system 30 has a handle 32 rotatably retained by the cover structure 25. When the handle 32 is turned by the user to actuate the actuation mechanism, the lenticular plate 20 is caused to slide repeatedly a specific distance, first in one direction, such as toward the upper end of the cover structure 25, then in a second direction, such as toward the lower end of the cover structure 25. The lenticular plate 20 thus reciprocates longitudinally over the surface of the stationary coded image member 12. Because the lenticular plate 20 is effectively clear, its motion is virtually imperceptible to the eye with the animating picture as a whole remaining fixed in position while the subject within it appears to come to life and move magically.

As disclosed herein, embodiments of the coded image members 12 can take the form of color-in cards, which can preferably be fabricated of heavy paper or card stock printed using conventional methods. Thin paper may also be used, but it is more prone to accidental creasing or warping which might otherwise force the plate 20 slightly up and away from its surface when the lenticular plate 20 is positioned flat up against it. Such creasing or warping would compromise the ability of the lenticular lenses of the plate 20 to focus accurately on the coded images 14.

The coded images 14, which may be entire depictions of a given subject or just a portion thereof, are typically formed by a plurality of fine, interlaced strips derived from a fixed number, usually four to six, of slightly different drawings of the subject. Descriptions of coded image animation devices are set forth in a plurality of the present inventor's own patents, including U.S. Pat. Nos. 5,901,484, 6,286,873, and 7,331,132, all incorporated herein by reference as if fully set forth. Together, the plural coded drawings of the coded images 14 complete one animation cycle, such as one complete gallop of a horse. Each image 14 contains multiple interlaced, abutting, and striated clumps of these four to six drawing phases precisely sized so that the width of the clump matches the width of each lens of the lenticular plate 20. When the lenticular plate 20 is positioned over such an image 14, the lenticles magnify specifically-corresponding areas of each clump or phase of the image 14 at one time so that a coherent image of one of the animation phases of the coded image 14 is decoded and displayed. Then, when the lenticular plate 20 is made to slide a distance over the coded image 14, all the while precisely guided to maintain its X/Y relationship to it, the lenticles of the lenticular plate 20 sweep across one coded image to the next, coherently decoding and displaying a first image, then another, and yet another until all coded phases of the coded image 14 are displayed thus creating the illusion of motion in the mind of the observer.

It will be understood that coded image members 12 according to the invention could simultaneously bear one or more coded images 14, which again can be entire subjects or portions thereof, in conjunction with non-coded images that likewise could be entire subjects or portions thereof. Unlike non-coded images or image portions, coded image portions 14 may not appear wholly recognizable until they are viewed through the lenticular plate 20 of the base structure 22.

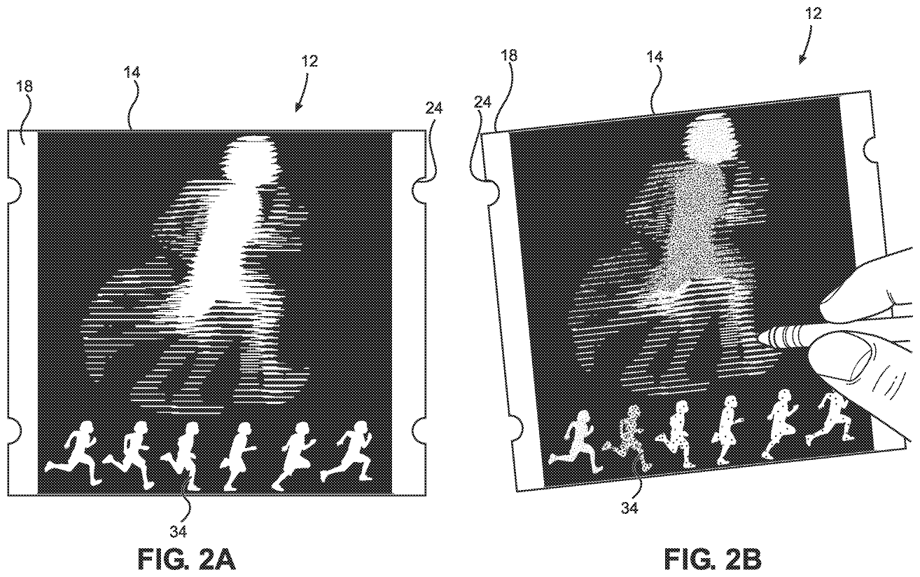

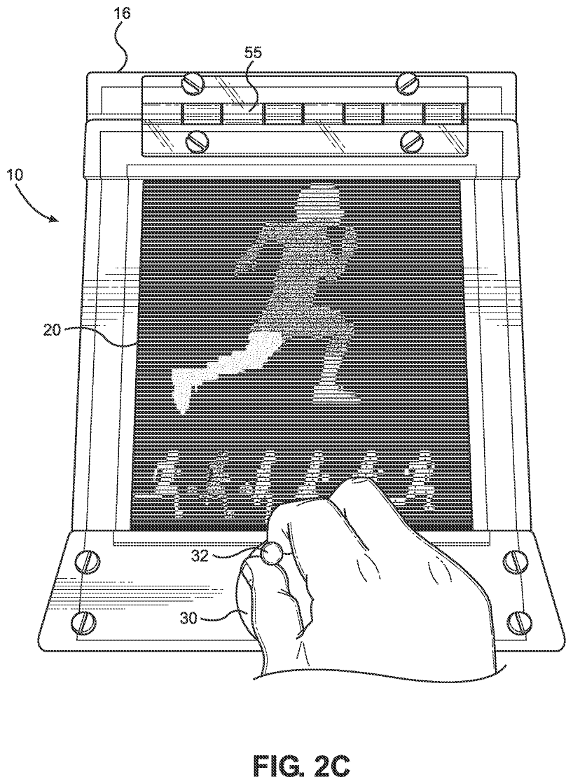

A variety of different approaches to produce the coded image members 12 would be possible within the scope of the invention. For example, coded image members 12 can be formed as color-in cards as in FIGS. 2A through 2C. There, the coded image member 12 includes both one or more coded image portions 14, each formed by interlaced coded image strips, and one or more non-coded image portions 34, which may be referred to as literal images 34. The literal images 34 could be entirely or partially formed as blank images with clear outlines or borders, or the literal images 34 could be partially or entirely pre-completed.

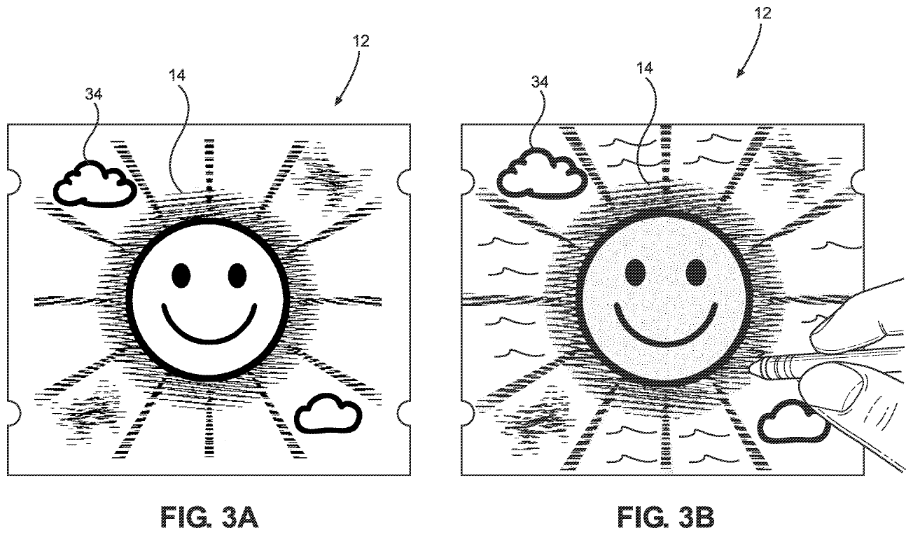

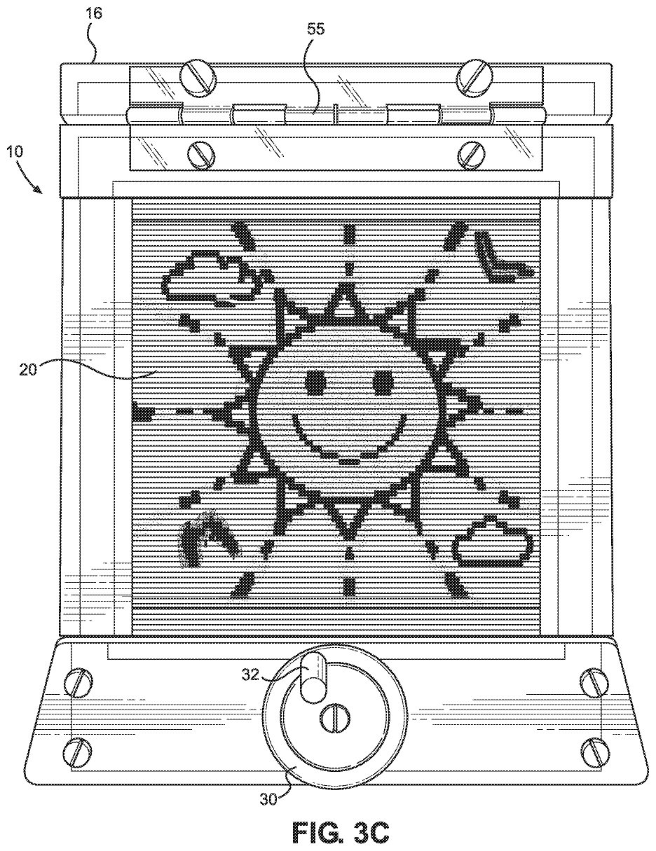

Both the coded image portions 14 and the non-coded image portions 34 can, but need not necessarily, relate to an overall theme of the particular picture of the coded image member 12 as a whole. For example, as in FIGS. 3A through 3C, the coded image member 12 may have literal black and white non-coded image portions 34 of clouds, suggesting a sky, with a central coded image 14 of a smiling sun. The smiling face of the sun itself may not be coded, but the rays emanating from the sun may be, as might the birds surrounding it.

In this manner, though the coded images 14 themselves may not be wholly literal, the non-coded, literal images 34 in such a picture are sufficient to help users, such as young children, intuit what they are coloring. In this regard, it will be noted that, while coded image portions 14 within a given scene tend to have outlines that are less than clear prior to decoding by the lenticular plate 20, the user may better recognize exactly what those subjects are through the ambience created by the neighboring literal, non-coded images 34. With that, the user may better choose how to color in the coded image portions 14. Thus, for example, in a garden scene containing literal images 34 of flowers and leaves, the user may more easily recognize coded image portions 14 of other flowers, a butterfly, or some other complementary feature. Through the combination of literal, non-coded images 34 with coded image portions 14, the potential of the coded image animation medium is extended by enabling the user to enhance and complete the coded image portions 14 with the user's own personal touch. In this manner, the present invention overcomes the prior art's tendency to rule out user participation in the augmentation or completion of coded image portions 14 that has previously constrained the appeal of the art.

When the coded image member 12 is placed into the viewing device 16 and the lenticular plate 20 is closed over it, the coded image portions 14 of the picture visually cohere due to the effect of the lenticular plate 20 and become as recognizable as their neighboring literal images 34 with the added effect that, as the user turns the crank system 30, the sun's rays appear to rotate and radiate while the birds appear to flap their wings realistically. It is important to understand that, because the original printed coded image 14 contains the animation, it does not matter if the user has colored in the coded images 14 carefully or not; the pre-printed coded images 14 themselves, usually printed in black, will always appear to animate clearly and sharply, enhanced by the color the user has added to their general area.

As in FIGS. 3A through 3C, embodiments are contemplated wherein the coded image 14 is defined by interlaced black lined image portions, which could be referred to as clumps, on a plain white field. Alternatively, as in FIGS. 2A through 2C, a color-in design approach can be employed. There, a blank white or light-colored coded image 14 formed from interlaced coded image strips of a plurality of discrete images is set against and bounded by a plain black or very dark outlining and a dark field background. The coded image 14 could additionally or alternatively be outlined by light lines, raised lines, embossed lines, or other outlines differentiating from the surrounding portion of the coded image member 12. Where a strip of a coded image does not contact a strip of a successive or preceding coded image, that strip will be outlined. However, where strips of successive coded images are in contact, as with the body portion of the character in this example, a continuous, blank image portion will be presented.

Such an approach advantageously ensures that the unskilled user will be able to color in the coded image 14 with the appearance of being exactly completed within the area of the coded image 14. No matter how inaccurately the user applies their crayons or markers to the coded image member 12, the colored markings will only show in the white or light image areas of the coded images 14 and coloring outside of the area of the coded images 14 will virtually vanish in the black or dark field background. Thus, the animated coded images 14 will appear to be colored-in precisely with vivid color and with no apparent distracting color bleed around them.

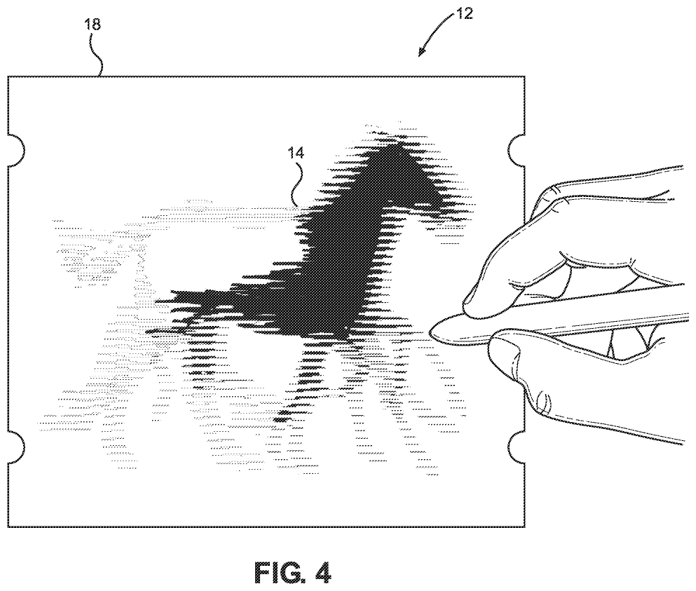

Looking to FIG. 4, a more challenging color-in coded image member 12 as might be more intended for adults can be produced in which the coded image 14 itself, which again is composed of clusters of fine horizontal lines, is printed as faintly-outlined with a light shade of a neutral color, such as gray, set against a plain white field background. Using a fine point pen, marker, or other implement, the user is invited to fill in these fine horizontal lines and clusters of the coded image 14 with a darker color. The user thus completes the coded image itself. In such practices of the invention, it may be practically necessary to have the coded images 14 sized to pair with a lenticular plate 20 that contains gross lenses, such as 10 lpi (lenses per inch) or grosser. A 10 lpi lenticular plate, for instance, will pair with a coded image 14 comprised of image clumps sized to approximately one tenth of an inch each. Thus, in the case of a six phase animation, each of the six horizontal lines within that clump will be the height of 1/60^{th} of an inch, which, although extremely thin, can be colored-in sufficiently by the steady-handed user.

If the lenticular plate 20 and complimentary coded images 14 are of sufficiently gross resolution, such as between 10 lpi and 20 lpi, the user may be offered the opportunity of printing their own cards at home on a standard desktop printer. Digital files, provided for example by the toy's manufacturer, could be downloaded by the user from the internet, home-printed, cut out with scissors, colored-in, registered to the device and made to animate. Though the calibration in printers may subtly vary from one brand to the other, sufficient grossness of lenticular lens count and coded image lines as described above will generally ensure that the results will be acceptable.

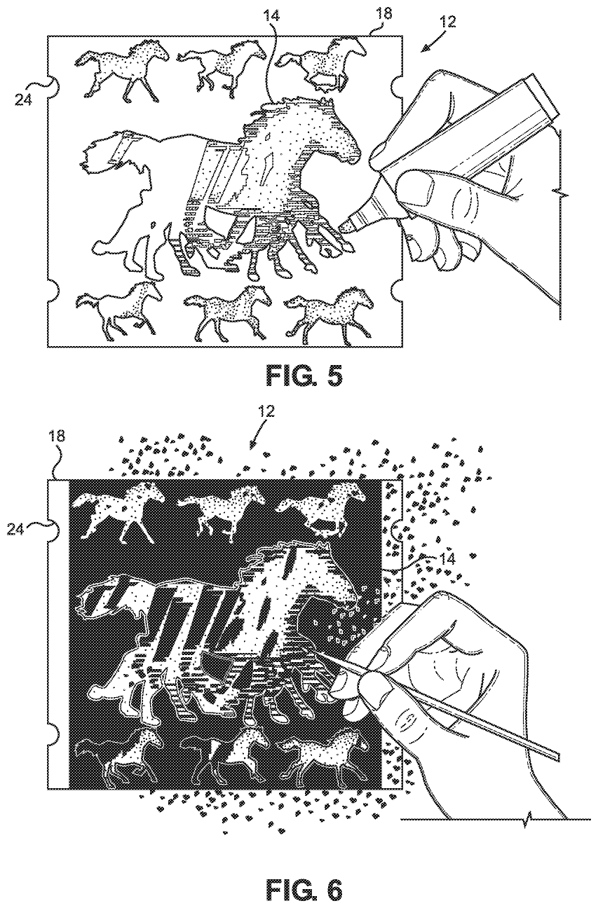

Other embodiments of the invention can incorporate coded image members 12 with image-reveal coded images 14 as in FIGS. 5 and 6, for instance. As in FIG. 6, a completely pre-designed, full-color coded image 14 can be designed and pre-printed onto the panel 18 of the coded image member 12 and then disguised with a printed, obscuring overlay. In the finished coded image member 12 furnished to the end user, this hidden coded image 14 is made visible by the user, such as by scratching away a concealing black surface, sometimes described as scratch art. In other practices, as in FIG. 5 for instance, the coded image panel 18 can have a coded image 14 that is revealed when the coded image member 12 is exposed to a reagent, such as a chemical or water-filled pen. For example, coloring or other aspects of the coded image 14 and surrounding designs can be concealed or created by a hydrochromic ink or leuco dye printed overlay. With this, the coloring or other aspects of the coded image 14 can be revealed by application of a water- or chemical-filled drawing implement. The coded image 14 can become permanently exposed, or it could fade back to the original color when the activating reagent dries. As shown in FIGS. 5 and 6, the coded image member 12 can contain perceptibly printed or otherwise formed outlines on the obscuring surface layer to help the user know where to scratch or where to apply the reagent to reveal the hidden images.

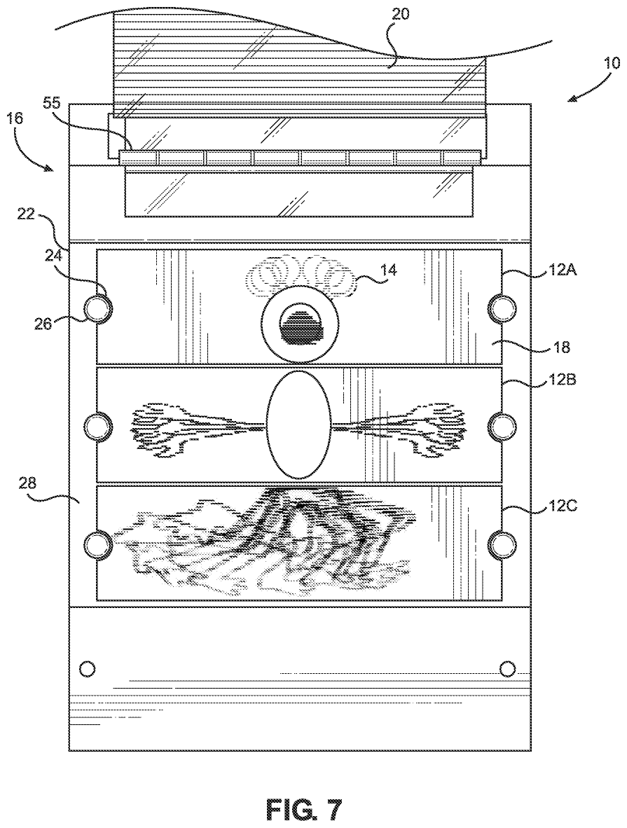

Looking further to FIG. 7, further practices of the invention can employ multiple coded image members 12A, 12B, 12C, 12n in coordination with a viewing device 16 crafted to retain plural coded image members 12A, 12B, 12C, 12n simultaneously, such as in juxtaposition, overlapping, or otherwise. Each coded image member 12A, 12B, 12C, 12n can include a coded image 14 on a coded image panel 18. As in FIG. 7, each coded image member 12A, 12B, 12C, 12n has opposed alignment formations 24 comprising inlets or cutouts, and the viewing device 16 has plural sets of alignment formations 26 comprising posts, buttons, pins, or other projections for engaging the alignment formations 24 of retained coded image members 12A, 12B, 12C, 12n.

Under such constructions, varied image displays can be achieved by mixing and matching coded image members 12A, 12B, 12C, 12n. In the depicted example, three coded image members 12A, 12B, and 12C are configured to be retained to cooperate to depict a creature. It will be understood that innumerable different depictions and types of depictions are possible. In the example of FIG. 7, a first coded image member 12A is crafted to depict a head, a second coded image member 12B is crafted to depict a midsection, and a third coded image member 12C is crafted to depict a lower body portion. Several options for coded image members 12A, 12B, 12C, 12n of each type can be provided. With this, coded image members 12A, 12B, 12C, 12n can be mixed and matched to create multiple design permutations.

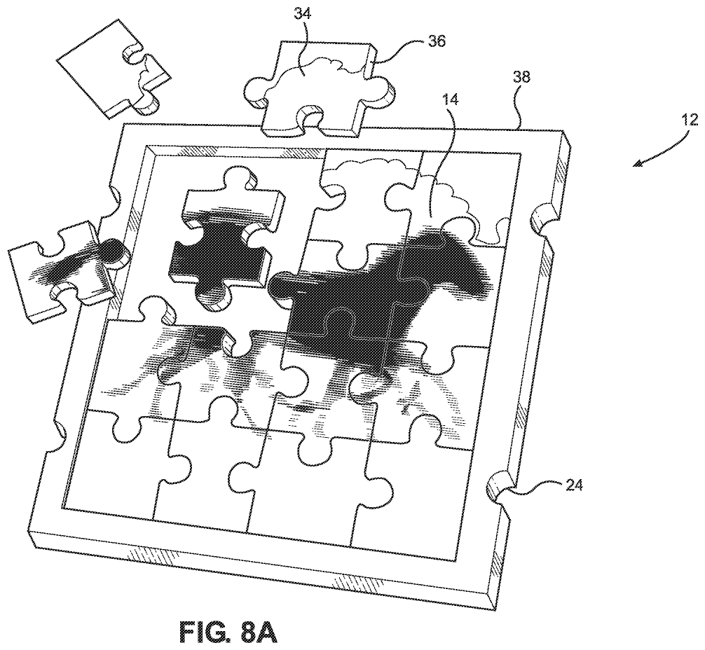

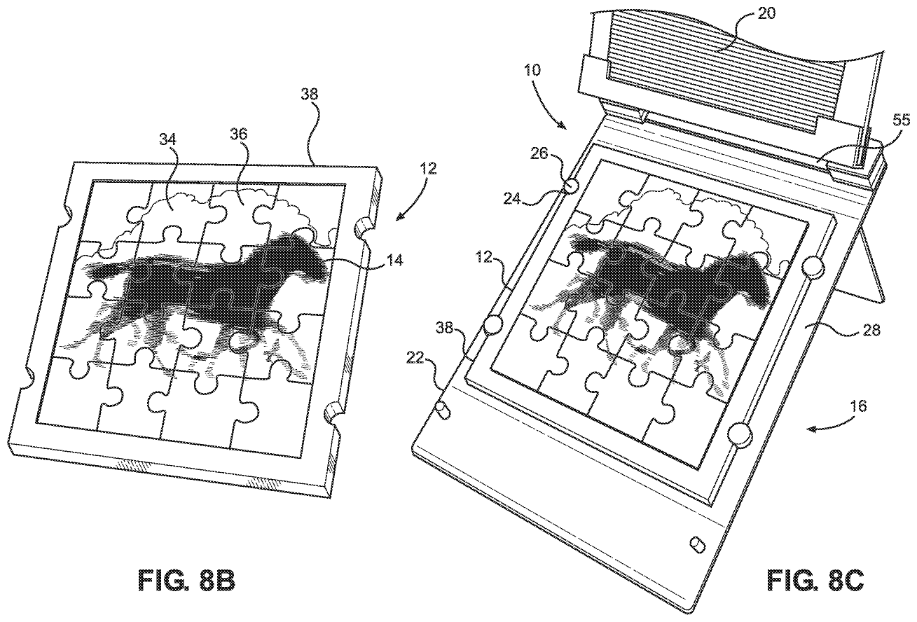

As shown in FIGS. 8A through 8C, still other practices of the invention could incorporate coded images 14 formed from plural jigsaw puzzle pieces 36, each with an image portion applied thereto, whether as a coded image 14 or as a static or non-coded image 34. With this, an animating jigsaw puzzle can be assembled from puzzle pieces 36 that cooperate to retain a pre-printed, full color, fully visible coded image 14. In such embodiments, the viewing device 16 could again include alignment formations 26 that project from the platen 28 of the viewing device 16. Rather than being disposed directly on the platen 28 of the viewing device 16, the puzzle pieces 36, which can be made of traditional thickness puzzle board material and printed by conventional means, are assembled by the user into a recessed area within a separate platen 38. The separate platen 38 has alignment formations 24 around its perimeter which can be similar to those described above for the coded image members 12. With that, the separate platen 38 retaining the puzzle pieces 36 can be disposed atop the platen 28 of the viewing device 16.

An indentation can be provided for receiving the puzzle pieces 36, whether directly in the platen 28 of the viewing device 16 or in the separate platen 38. The indentation and the thickness of the puzzle pieces 36 can be coordinated in depth and thickness, such as with the puzzle pieces 36 having a thickness slightly greater than the depth of the indentation of the platen 28 or 38. With that, when the assembled puzzle pieces 36 are inserted into the viewing device 16 as in FIG. 8C, the surfaces of the assembled pieces 36 are in a plane marginally above the perimeter of the indentation. Consequently, full, yet gentle contact is made by the pieces 36 with the back of the lenticular plate 20 when the cover structure 25 is closed upon the coded image member 12.

The mechanics of the viewing device 10 are specifically designed to deliver a clear and convincing impression of realistic animated movement when operated by the average user. This inventor has determined that three factors are necessary to achieve a successful animation effect using lenticular technology. First, the different individual images that are presented to the eye in succession must each be clearly seen by both eyes simultaneously. Second, the rhythm and cadence of the displayed animation must be of a realistic and believable nature. Third, the repeating animation cycles thus displayed must play rhythmically and continuously for a sufficiently continuous period of time to make a distinct mental impression upon the observer. The present animation device 10 specifically addresses each of these factors.

As stated, to convey a convincing animation effect, a series of individually clear images, each a little different than the one previous, must be presented to the eye in rapid succession. The clarity of these individual images, while changing from one to the next so quickly as to be only subconsciously perceived by the observer, establishes the observer's expectation of and perception of continuous motion. To achieve this in the animation device 10, both the coded image 14 and the lenses of the lenticular plate 20 are designed to be disposed to communicate laterally relative to the observer's perception rather than vertically. Even with complex animations composed of more than six-phase coded images, the horizontal bias of these two elements ensures that the observer's two eyes will simultaneously see only a single discreet animation phase at a given time. If the lines forming the coded images 14 and the lenses of the lenticular plate 20 were instead arranged vertically for such a complex animation, with animation then being achieved by lateral relative movement between the coded image member 12 and the lenticular plate 20, each of the observer's two eyes would instead see two or more different image phases at a given time thereby resulting in visual confusion that would compromise the animation effect. Although perhaps less preferable, such embodiments are within the scope of the invention except as expressly excluded by the claims.

Secondly, it is again noted that the subject must be made to animate in such a way as to help the observer suspend disbelief. The user must allow him or herself, even fleetingly, that what he or she is seeing is alive. To achieve this, the animating subject must appear to move with a realistic cadence and rhythm, as if obeying laws of physics found in the real world. For example, for the motion of the image of an animated galloping horse to appear convincing, the horse would need to gallop at the rate of two to three complete gallops and thus two to three animation cycles per second, not significantly faster or slower. This rate of approximately three cycles per second has proven ideal as well for convincing animation of many popular animal and human subjects, such as leaping cats, flapping birds, and running or jumping human or cartoon characters.

Further, the gearing and distance of advancement of the lenticular plate 20 by the actuation mechanism are calibrated for rhythmic, realistically-cadenced, and apparently continuous animation. For example and again taking a crank system 30 as a non-limiting actuation mechanism, this inventor has determined that the average user will rotate the crank system 30 on the viewing device 16 at the rate of approximately one and one-half (1.5) rotations per second. The viewing device 16 is geared, and the lenticular plate 20 and the coded image member 12 are calibrated, to cause this natural cranking motion to advance the lenticular plate 20 in relation to the cover structure 25 and the coded image member 12 at such a rate of speed that three repeating cycles are presented to the eye per second when the crank system 30 is operated at 1.5 rotations per second.

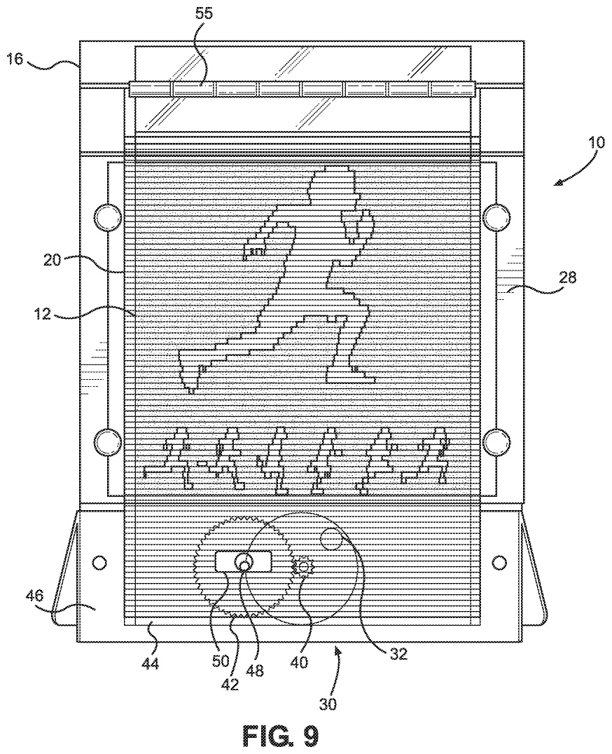

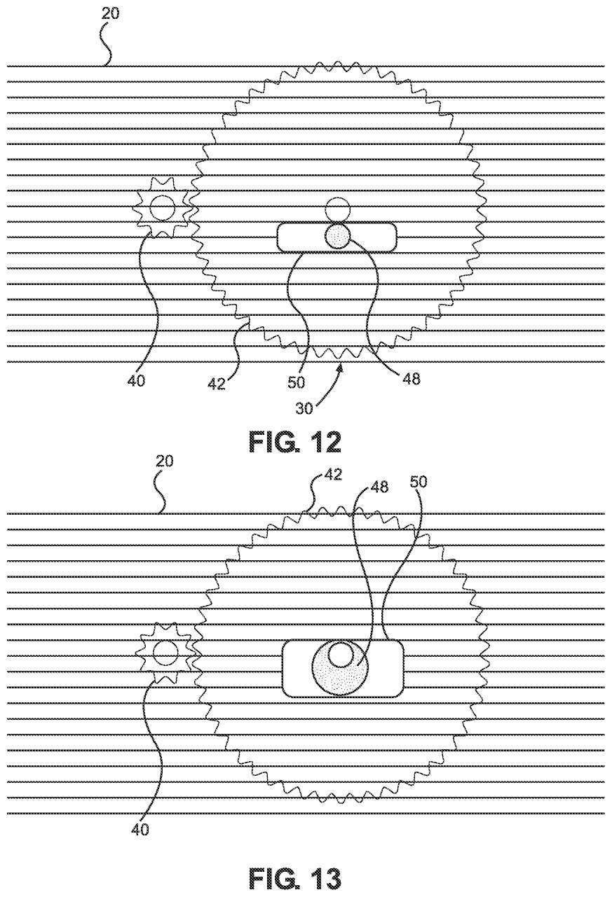

In certain, non-limiting examples, as can be perceived by reference to FIGS. 9 through 13, the crank system 30 the viewing device 16 incorporates two gears 40 and 42, both retained to underlie a cross plate 46 that is disposed adjacent to the bottom of the viewing device 16 and that holds the handle 32. A primary gear 40 is coaxial with and directly driven by the handle 32. The primary gear 40 in this example includes ten (10) teeth and meshes with a larger, secondary gear 42 that has fifty (50) teeth for a 1/5^{th} gear ratio. A precisely offset actuation member 48, such as a pin as in FIG. 12 or a cam as in FIG. 13, is fixed to rotate with the secondary gear 42 and to engage a snugly-fitted laterally communicating aperture 50, such as a slot, that is fixed to move with the lenticular plate 20.

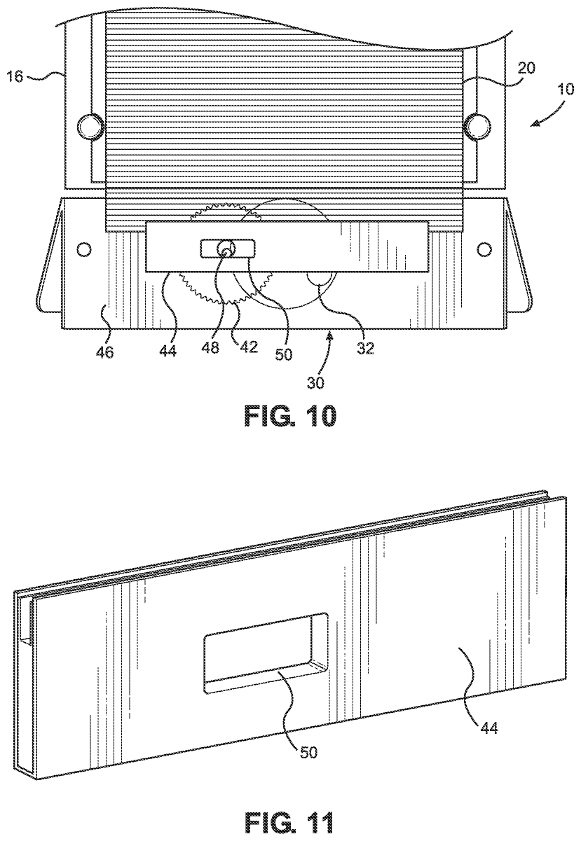

The aperture 50 could be directly incorporated in the lenticular plate 20 as in FIGS. 9, 12, and 13, or it could be disposed in a fitting member 44 that is in turn fixed to the lenticular plate 20 as in FIGS. 10 and 11. By forming the aperture 50 in a fitting member 44 rather than in the lenticular plate 20, the plate 20 can be efficiently cut from a larger extruded sheet and installed without further machining. The lenticular plate 20 could thus be generally sourced and cut to size without a need for custom manufacture.

The precise offset of the actuation member 48 is such that, when rotated, the actuation member 48 will move the lenticular plate 20, which is simultaneously slidably guided by accurately positioned left and right lateral engagement structures, the distance of a given number of lenticles, such as five, and thus that given number of animation cycles in one direction for half of the revolution of the actuation member 48. As the user continues to crank and the actuation member 48 continues to rotate, the actuation member 48 reaches its apex and reverses the sliding direction of the lenticular plate 20 relative to the remainder of the cover structure 25. The actuation member 48 returns the lenticular plate 20 to its starting position upon completion of the second half of the revolution of the actuation member 48.

The result of the actuation mechanism moving the lenticular plate 20 at the desired rate is the display of realistically-cadence animation. At the expected average hand-cranking rate of 1.5 (one and a half) rotations per second, or fifteen teeth per second, and with five teeth causing the advance of one lens width and one animation cycle, the viewing device 16 will display animation at the ideal rate of three (3) cycles per second. It will again be noted that, except as expressly limited by the claims, other actuation mechanisms, other gearing, and other rates of movement are within the scope of the invention as is the distance chosen to advance the lenticular plate 20.

It will be understood that, at the moment when the lenticular plate 20 is driven by the actuation member 48 to one extreme direction or the other, just before reversing direction, the lenticular plate 20 will momentarily cease to move in the longitudinal direction even where the handle 32 is continuously rotated. This dwell time may be minimized by ensuring that the aperture 50 is fitted snugly to the actuation member 48. Dwell time can additionally or alternatively be minimized by employing a larger eccentricity of the actuation member 48, such as through a larger cam.

Except as the claims might expressly preclude, movement of the lenticular plate 20 or, in other embodiments, the coded image member 12 could be triggered by actuation mechanisms other than a rotatable, manual crank system 30. Again without limitation, other actuation mechanisms could include manually operate levers, slide structures, direct engagement, rotatable drop cams, air bladders, gravity drop systems, spring-loaded pull cords, other manual movement systems and even automated, motorized actuation systems.

In any example, it is desirable to cause the animation in the device 10 to be exhibited smoothly and continuously in one direction for a period of sufficient duration to make a mental impression upon the observer. Returning to the example of a galloping horse, the display of only one or two gallops—one or two cycles—may be too fleeting to impart a mental impression upon the casual observer. This inventor has learned that three continuous animation cycles, displayed at a realistic cadence, is the minimum number necessary to create such an impression. When the actuation mechanism is operated by the user, the gearing and other dimensional relationships are such that the lenticular plate 20 will advance in one direction equivalent to approximately five (5) lens widths before reversing direction. This permits the animation to play continuously and in one direction for a duration of approximately five unbroken animation cycles before reversing itself. Thus, the viewing device 16 can deliver five (5) continuous animation cycles at a realistic cadence.

It will again be noted that, to perform optimally, lenticular technology demands precise x/y alignment between the strips forming the coded images 14 and the lenticles of the lenticular plate 20 even while one is made to slide over the other. Clear animation further demands that the printed surface of the coded image 14, positioned directly beneath the lenticular plate 20, always be retained at the precise focal length of the lenticles of the lenticular plate 20. In most cases, the focal length of the lenticles of lenticular plates 20 is located at the exact back of the lenticular plate 20 so that the plate 20 and the surface of the printed coded image 14 must always be put in direct contact with one another as one slides against the other.

Generally speaking, the grosser the lenticular lenses and the corresponding coded images 14, the less demanding the tolerances required to deliver an acceptable animated display. To take advantage of this, because this animation device 10 may be operated by a child, possibly using home-printed, scissor-cut coded image members 12, it is preferable that the lens count of the lenticular plate 20 and the pitch of the coded images 14 be relatively gross, such as between 20 lpi and 10 lpi.

However, regardless of how gross the lens count and coded images 14 are, the viewing device 16 must still be designed to ensure accurate registration of coded images 14 and the lenticular plate 20. In embodiments of the animation device 10, accurate registration can be facilitated in a plurality of ways as is further described hereinbelow and shown in the drawings.

For instance, the platen 28 upon which the user places the coded image member 12 on the viewing device 16 is positioned so that, when the lenticular plate 20 is closed upon it as part of the cover structure 25, the back of the lenticular plate 20 will rest fully and gently upon the surface of the coded image member 12, thus retaining the lenses of the lenticular plate 20 at the exact correct focal length from the coded image 14. The coded image member 12 can have two pairs of opposed alignment formations 24, such as notches, in its lateral edges. The formations 24 are disposed so that, when the coded image member 12 is place on the platen 28 by the user, the formations 24 accurately engage with four correspondingly disposed, fixed alignment formations 26 on the viewing device, two to each side of the platen 28.

The alignment formations 24 and 26 cooperate to retain the coded image member 12 so that, when the hinged cover structure 25 of the viewing device 16 is pivoted to be disposed atop the coded image member 12, the coded images 14 printed or otherwise applied to the coded image member 12 will be in accurate x/y alignment with the lenticles of the lenticular plate 20. In addition to registering the x/y axis of the coded image member 12 in relation to the lenticular plate 20, the alignment formations 24 and 26 serve to hold the coded image member 12 firmly in place as the lenticular plate 20 is caused to slide longitudinally the surface of the coded image member 12. Importantly, the alignment formations 26 of the viewing device 16 are positioned outside the perimeter area of where the lenticular plate 20 will fall when the cover structure 25 is pivoted to a closed position. This facilitates the necessary full face-to-face contact between the coded image member 12 and the surface of the lenticular plate 20.

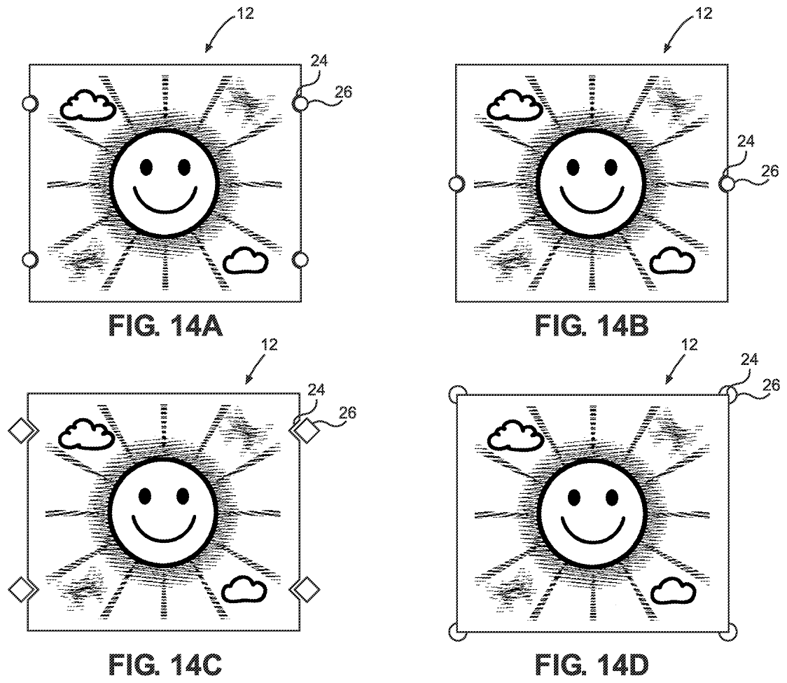

Looking further to FIGS. 14A through 14D, it will be understood that the alignment formations 24 and 26 can pursue numerous different configurations and combinations. For instance, the alignment formations 26 could be formed as two opposed pairs of round posts as in FIG. 14A, as a single pair of round posts as in FIG. 14B, as triangular or diamond-shaped posts for engaging V-shaped alignment formations 24 in the coded image member 12 as in FIG. 14C, as pairs of opposed round posts with open segments for receiving corners of the coded image member 12 as alignment formations 24 as in FIG. 14D, or in numerous other effective shapes and configurations. In instances where the coded image members 12 are to be home-printed and cut out by the user, which may happen with children's scissors by a young user, triangular scalloped insets forming the alignment formations 24 in the coded image members 12 may be preferred in conjunction with correspondingly shaped alignment formations 26 as in FIG. 14C.

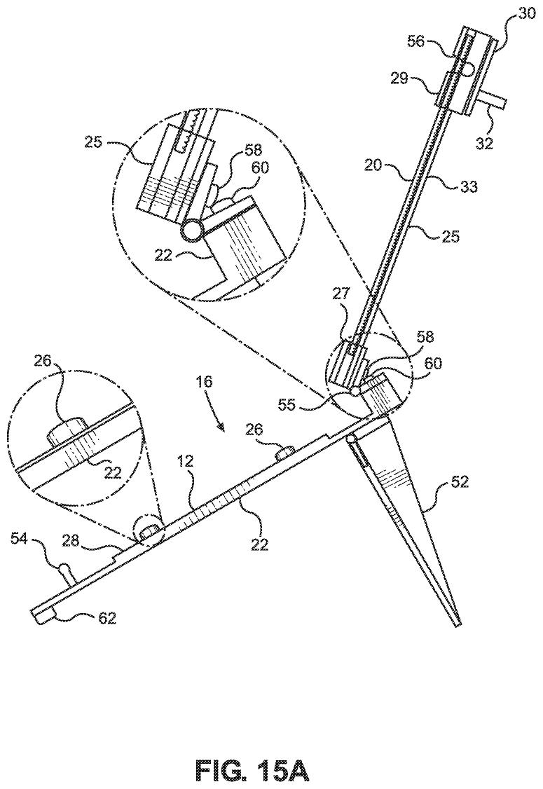

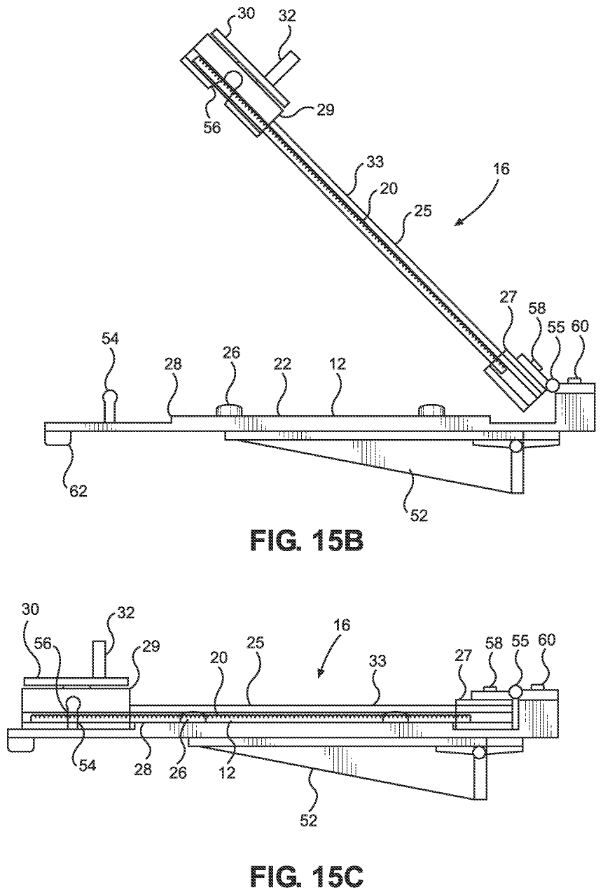

An embodiment of a viewing device 16 according to the invention is depicted in side elevation in FIGS. 15A through 15C. There, the lenticular plate 20 is retained by the cover structure 25 with the left and right frame sections 31 and 33 (as seen in FIG. 1C, for instance) projecting laterally beyond the lateral edges of the lenticular plate 20 and with the left and right frame sections 31 and 33 atop the lenticular plate 20 when the plate 20 is in a closed position. The alignment formations 26 are formed each with a height sufficient to retain a coded image member 12 in place, but the cover structure 25 and the alignment formations 26 are crafted in coordination so that the alignment formations 26 do not impinge on the underside of the lateral frame sections 31 and 33 of the cover structure 25 when the cover structure 25 is pivoted to a closed position. The alignment formations 26 can project directly from the platen 28 or from positions adjacent to the edges of the platen 28. In either instance, wherein the platen 28 is considered to have a platen surface disposed in a plane, the alignment formations 26 can project above the plane of the platen surface thereby to promote retention of the coded image member 12.

Furthermore, as best seen in FIG. 15A, the upper edges of the alignment formations 26, the edges proximal to the hinge 55 of the cover structure 25, are slanted to an acute angle toward the hinge 55 of the cover structure 25. In use, the base platform 22 may be retained at an inclined angle, such as 30 degrees from horizontal, by a leg structure 52. When the platform 22 is so disposed, the slanting of the alignment formations 26 serves to catch and retain the coded image member 12. With that, inadvertent displacement of the coded image member 12 is further prevented, including where the coded image member 12 is unintentionally creased, bowed, or warped, which might otherwise cause it to tend to lift from the surface of the platen 28. Other registration systems are possible and within the scope of the invention except as the claims expressly exclude.

Accurate alignment and clear animation are further facilitated by providing alignment registration between the cover structure 25 and the base platform 22. Aligned registration between the cover structure 25 and the base platform 22 could be ensured in a plurality of ways. In the depicted embodiment, one or more alignment projections 54, such as posts or pegs, extend from the base platform 22 to be matingly received by correspondingly disposed receiving formations 56, such as apertures, boreholes, or other formations, in the cover structure 25. The alignment projections 54 and the receiving formations 56 can have a positive engagement mechanism, such as spring-loading, a snap fit, or a spring-loaded, snap-fit positive engagement as in the embodiment of FIGS. 15A through 15C to protect against inadvertent displacement of the cover structure 25, such as by an unintentionally creased or warped coded image member 12. In the example of FIG. 15, the alignment projections 54 terminate in bulbous end portions that are snap fit into correspondingly shaped and sized portions of the receiving formations 56. Of course, the alignment projections 54 and the receiving formations 56 could be oppositely disposed within the scope of the invention.

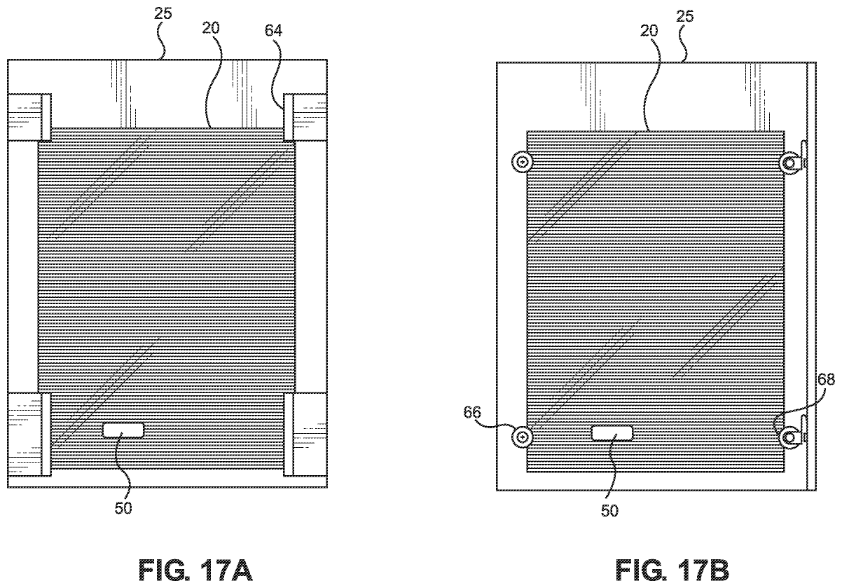

To further ensure accurate x/y alignment between the coded image member 12 and the lenticular plate 20 despite longitudinal movement of the lenticular plate 20 during actuation thereof, the cover structure 25 of the viewing device 16 has accurately positioned left and right lateral engagement structures for the lenticular plate 20. By way of example, the cover structure 25 can have lateral edge guide channels or ridges 64 for receiving lateral edges of the lenticular plate 20. As FIG. 17A shows, for instance, the guide channels or ridges 64 need not communicate over the complete length of either side of lenticular plate 20. For instance, to reduce friction between the edges of the lenticular plate 20 and the inside of the channels or ridges 64 during sliding, plural, such as four, guide channel or ridge portions 64 may be employed, such as with two channel portions 64 on the left and two on the right positioned toward the top and bottom ends of the cover structure 25 respectively. In the depicted embodiment, each guide channel 64 comprises an edge guide that provides a lateral surface to be disposed outboard of the lenticular plate 20 and an inwardly extending section that overlies the lenticular plate 20 thereby to sandwich the plate 20 between the inwardly extending section and the facing surface of the cover structure 25. Opposed inside surfaces of the guide channels, ridges, or other guide formations 64 are disposed to engage the lenticular plate 20 closely to prevent unintended lateral movement but to permit unhindered sliding of the lenticular plate 20 during actuation of the crank system 30 or other actuation mechanism.

As FIG. 17B shows, it would also be within the scope of the invention to incorporate spring-loaded channels, ridges, wheels, or other guide formations 66 and 68 as alignment and guidance structures to cause to prevent misalignment of the lenticular plate 20 during movement. In FIG. 17B, the guide formations 66 and 68 comprise rotatable wheels over which the lenticular plate 20 can travel. Either or both set of wheels 66 and 68 can have a resilient base structure for biasing the wheels 66 and 68 into contact with the lenticular plate 20 and thereby to promote its alignment and smooth movement. For example, as in FIG. 17B, the wheels 68 to one side of the lenticular plate 20 are retained relative to the cover structure 25 by spring-loaded base members.

Based on the structure so disclosed, accurate x/y registration and full contact between the surfaces of the coded image member 12 and the lenticular plate 20 are promoted. For instance, the alignment formations 24 of the coded image members 12 and the alignment formations 26 of the base structure 22 ensure the relative positioning of coded image members 12, and accurate alignment between the cover structure 25 and the base platform 22 is ensured not only by the hinge structure 55 but also by the positive engaging mechanism operative between the alignment projections 54 of the base platform 22 and the corresponding receiving formations 56 of the cover structure 25. Moreover, where the positive engaging mechanism, such as a snap-fit or spring-loaded or a spring-loaded, snap-fit system as employed in this preferred embodiment, operates to receive and retain the alignment projections 54 within the receiving formations 56, full, close contact is promoted between the lower surface of the lenticular plate 20 and the image surface of the coded image member 12. With the alignment formations 24 and 26 of the coded image members 12 and the base structure 22 disposed outside of the lateral borders of the coded images 14 and the lenticular plate 20, accurate registration and full contact are promoted while the rendering of the animation of the coded images 14 is open and unobscured.

The present inventor has appreciated that, when viewing an animated image through a lenticular plate 20, it is preferable to view it straight on or at least within approximately 45 degrees to either side of straight-on because, the more oblique the viewing angle, the less distinct the animated image will appear to the eye. Therefore, the leg structure 52, which could be a hinged leg structure, a fixed leg structure, or some other design, is retained by the lower side of the base structure 22 to angle it toward the user, such as at 30 degrees from horizontal. The inventor has determined that this 30 degree angle ensures that most users who engage with the viewing device 16 while it is placed upon a support surface, such as a typical table top, will perceive the clearest animating image.

To reduce drag between the lenticular plate 20 and the coded image member 12, it is contemplated that a lenticular plate 20 could be employed with lenticles that have focal points a predetermined distance beyond the back of the lenticular plate 20. This would enable the lenticular plate 20 to be positioned above the surface of the coded image member 12 by a spacing gap thereby minimizing potential drag between the lenticular plate 20 and the coded image member 12. A spacing gap would also eliminate potential scratching to the back of the lenticular plate 20 and any unwanted transfer of drawing materials, such as crayon, from the surface of the colored-in coded image member 12 to the back of the lenticular plate 20. Even further, it would be possible within the scope of the invention for the lenticular plate 20 to be oppositely disposed with the lens surface facing downward to provide spacing between the plate 20 and the coded image member 12 while retaining ideal focal length from coded images 14. While such designs are possible, the constructions depicted herein are currently preferred for efficient production and use.

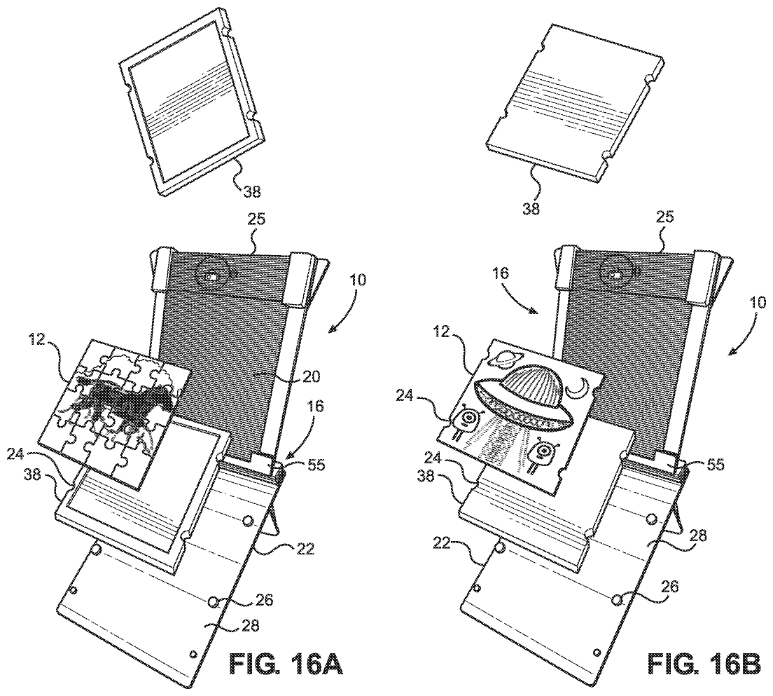

Another embodiment of the animation device 10 is depicted in FIGS. 16A and 16B. There, the animation device 10 permits conversion of a display from retaining and animating a color-in design to a jigsaw puzzle so that the device 10 can permit puzzle play, coloring, and animation. A lenticular plate 20 is again retained by a cover structure 25. The cover structure 25 is pivotable in relation to a base structure 22, and a platen 28 has alignment formations 26 that project therefrom. To facilitate conversion from a color-in configuration to a jigsaw puzzle configuration, a separable platen 38 is provided for being selectively disposed atop the platen 28 of the base structure 22. The separable platen 38 is reversible and has a first side with an indentation or recess therein and a second side that is flat. Alignment formations 24 extend through the platen 38 with corresponding shapes and locations to the shapes and locations of the alignment formations 26 of the base structure 22. With this, the platen 38 can be disposed on the base structure 22 with the first side facing upwardly for receiving a coded image member 12, which could be a jigsaw puzzle coded image member 12, in a nesting relationship. Alternatively, the platen 38 can be disposed with the second side facing upwardly so that one or more non-puzzle coded image members 12 can be disposed thereon. In either disposition, the platen 38 and a coded image member 12 can be disposed atop the platen 28 of the base structure 22 to be retained in position by the cooperation of the alignment formations 24 and 26.

Referring again to FIGS. 15A through 15C, because the hinged cover structure 25 of the viewing device 16 retains and houses the lenticular plate 20 and the actuation mechanism, it is comparatively heavy. Thus, to avoid putting undue strain on the hinge structure 55 when the cover structure 25 is opened, complimentary bumpers 58 and 60 of resiliently compressible material are disposed on the upper end surfaces of the base structure 22 and the cover structure 25 to limit the pivoting of the cover structure 25 and to permit a resting of the cover structure 25, such as at a tilt-back angle of approximately 70 degrees, against the base structure 22. The tilt-back angle also retains the cover structure 25 within easy reach of the user. Still further, to prevent inadvertent displacement of the viewing device 16, including during actuation of the actuation mechanism, frictional feet 62 are fixed to the lower corners of the base structure 22.

It will be understood that the invention for an animation device 10 is not limited to the particular embodiments shown and described above. For instance, as shown in FIGS. 18 through 26 for example, embodiments are contemplated wherein the lenticular plate 20 is not actuated for movement. Instead, relative movement and animation can be caused by a reciprocation of the coded image member 12 relative to the lenticular plate 20, such as by movement of the platen 28 below the lenticular plate 20. Each movement manifestation can be considered advantageous in certain respects. For instance, where the lenticular plate 20 is moved in relation to the cover structure 25 and the coded image member 12, the animated image advantageously remains in a fixed position as the lenticular plate 20 nearly invisibly travels over the coded image member 12. However, where the actuation mechanism is retained in the cover structure 25, the cover structure 25 may be considered to be relatively heavy and unwieldy. Movement of the platen 28 and the coded image member or members 12 retained thereon renders it efficient to dispose the actuation mechanism in the base structure 22. With that, the cover structure 25 need not support the actuation mechanism and is, therefore, rendered lighter and more easily manipulated.

Embodiments of the animation device 10 where the platen 28 and one or more coded image members 12 retained thereon are moved below the cover structure 25 and the lenticular plate 20 retained thereby are shown in FIGS. 18 through 26. There, the viewing device 16 again has a cover structure 25 that comprises a framework with an upper frame section 27, a lower frame section 29, and left and right lateral frame sections 31 and 33 to define a viewing opening. A lenticular plate 20 is retained to span the viewing opening, and the cover structure 25 coupled to a base structure 22 by a hinge structure 55. The lenticular plate 20 is retained by the cover structure 25 with the left and right frame sections 31 and 33 projecting laterally beyond the lateral edges of the lenticular plate 20.

As shown in FIGS. 18, 25, and 26, the left and right frame sections 31 and 33 are positioned to be atop and spaced from the lenticular plate 20 when the plate 20 is in a closed position. More particularly, the mid-portion of the lenticular plate 20 is spaced from the left and right frame sections 31 and 33 by retaining posts 68, two to each side of the lenticular plate 20, that are sized and positioned to maintain the lenticular plate 20 in the planar condition desirable for clear animation. Moreover and with particular reference to FIG. 20, the upper and lower frame sections 27 and 29 incorporate or comprise upper and lower rigid planing sleeves that matingly receive what may be considered the top and bottom end portions of the lenticular plate 20. The planing sleeves 27 and 29 have pockets aligned depth-wise with the retaining posts 68 that closely receive the end portions of the lenticular plate 20 further to induce or maintain the lenticular plate 20 in a planar condition. In cooperation, the planing sleeves 27 and 29 and the retaining posts 68 promote a planar condition of the lenticular plate 20 over plural spaced locations.

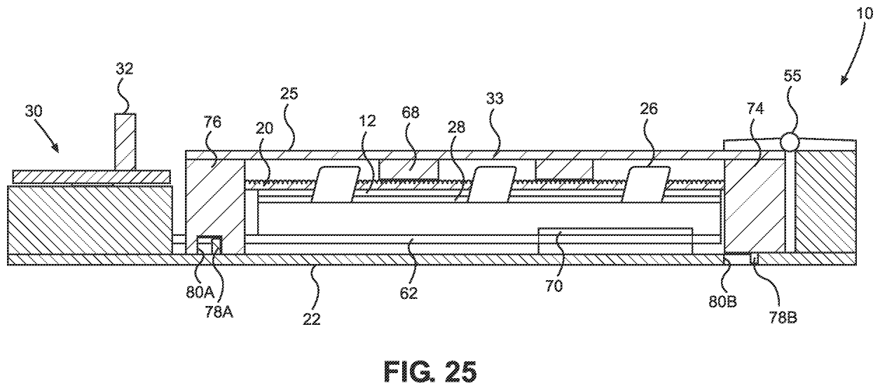

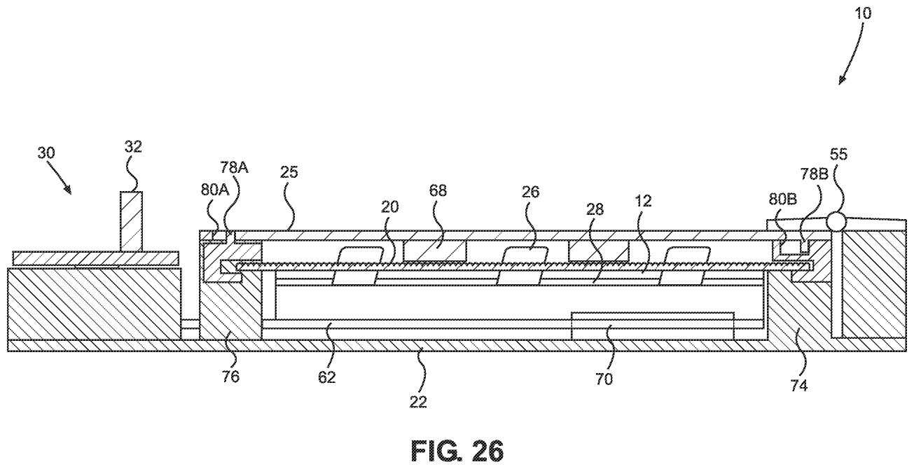

In the depicted embodiment, the platen 28 is retained for longitudinal sliding in relation to the base structure 22 by a carriage structure 62. Three longitudinally spaced, opposed pairs of alignment formations 26 project from the carriage structure 62 marginally lateral to the platen 28 and, when the cover structure 25 is closed, marginally lateral to the lenticular plate 20. As such, the alignment formations 26 border and sit astride of the platen 28 and the lenticular plate 20. Here, the alignment formations 26, which can be seen in profile in FIGS. 25 and 26 for example, project above the plane of the platen surface of the platen 28 a sufficient distance to retain a coded image member or members 12 in place, but the cover structure 25 and the alignment formations 26 are crafted in coordination so that the alignment formations 26 do not impinge on the underside of the lateral frame sections 31 and 33 of the cover structure 25 when the cover structure 25 is closed.

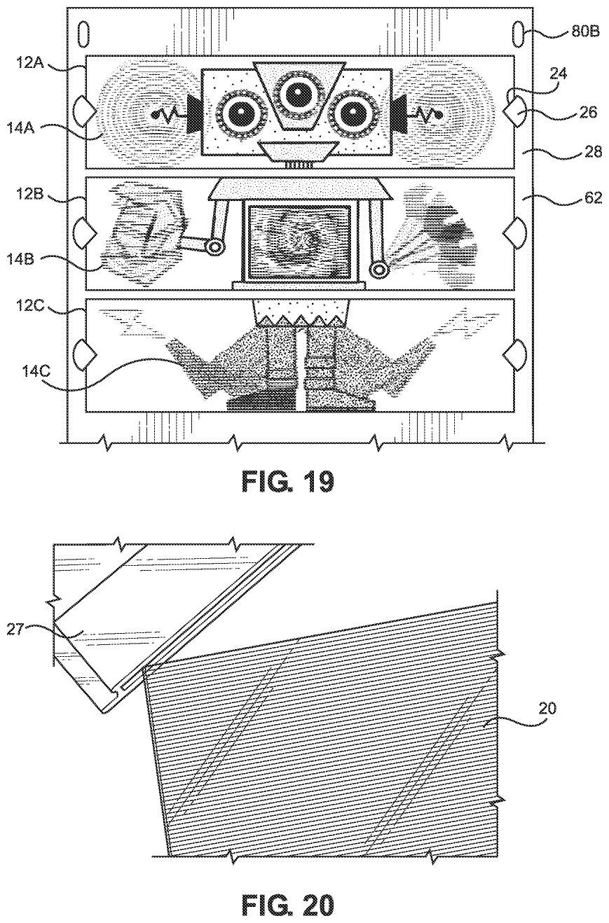

The alignment formations 26 are triangular or pie-piece shaped in lateral cross section with a point of the shape projecting centrally toward the opposing alignment formation 26. Furthermore, the upper edges of the alignment formations 26, again the edges proximal to the hinge 55 of the cover structure 25, are slanted to an acute angle toward the hinge 55 of the cover structure 25. The alignment formations 26 can be considered to comprise leaning towers or posts with pie-piece shaped lateral cross sections. Particularly when the platform 22 is disposed at an angle, such as by the leg structure 52, the slanting of the alignment formations 26 serves to catch and retain the coded image member or members 12 in cooperation with alignment formations 24 disposed in the coded image member or members 12, and accurate alignment of the coded images 14 with the lenticles of the lenticular window 20 is ensured.

Where three pairs of alignment formations 26 are provided as in the illustrated embodiment, one coded image member 12 itself with three opposed pairs of correspondingly shaped and located alignment formations 24 can be disposed atop the platen 28 with the alignment formations 24 and 26 cooperating to retain the coded image member 12 in a precisely coordinated position. Alternatively, as seen in FIG. 19, for example, first, second and third coded image members 12A, 12B, and 12C, each with one pair of correspondingly shaped and located alignment formations 24 in the lateral edges thereof, can be simultaneously retained for animation. The coded images 14A, 14B, and 14C could, for instance, themselves be coordinated, such as with the first coded image 14A comprising a head design, the second coded image 14B comprising a torso design, and with the third coded image 14C comprising a leg design to make a unified coded image rendering of the three coded images 14A, 14B, and 14C. With that, designs can be mixed and matched with plural different coded image options to create and animate varied designs, thus further expanding the user's ability to complete the animated image creatively even beyond the ability to color the same. As before, the alignment formations 24 and 26 of the coded image member or members 12 and the base structure 22 are disposed outside of the lateral borders of the coded images 14 and the lenticular plate 20 so that accurate registration and full contact are promoted while animation of the coded images 14 is unobscured.

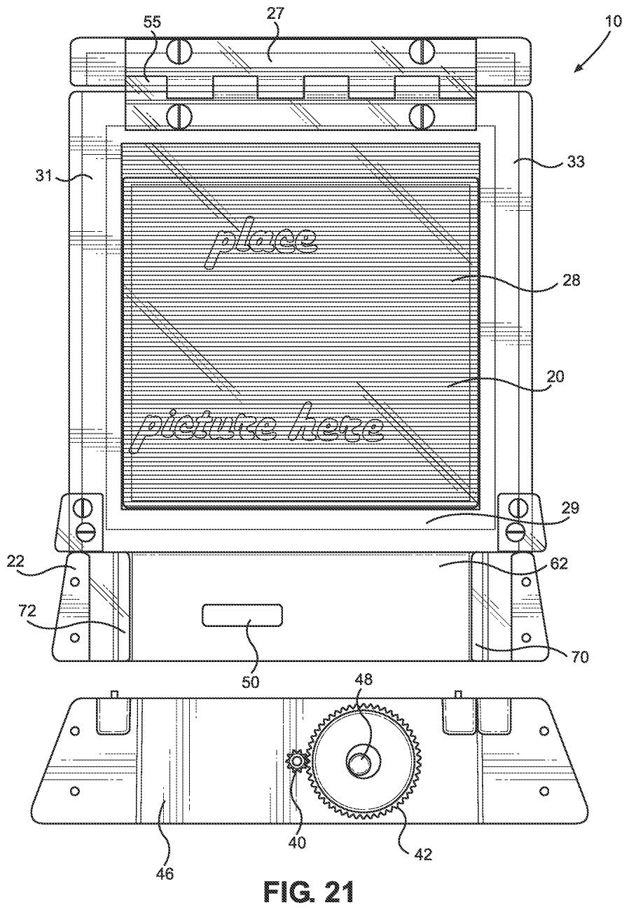

An actuation mechanism is operative to reciprocate the carriage structure 62 and thus the platen 28 and the coded image member or members 12 retained thereby in relation to the cover structure 25 and the lenticular plate 20. Again, the actuation mechanism could be automatic, such as by motorization, or it could be manual as shown. In FIGS. 18 and 21, for example, the actuation mechanism can be seen to comprise a manually-operated crank system 30 that is operative to reciprocate the carriage structure 62 longitudinally in relation to the base structure 22 to cause coded images 14 to appear to animate realistically.

Again without limiting the invention, the depicted embodiment of the actuation mechanism comprises a crank system 30 with a handle 32 rotatably retained by the base structure 22. When the handle 32 is turned to actuate the actuation mechanism, the carriage structure 62 and the platen 28 are caused to reciprocate over a specific distance longitudinally under the surface of the stationary lenticular plate 20. Again, while the depicted longitudinal or up-and-down reciprocation may be preferred for optimal viewer perception of animation, lateral or left-and-right reciprocation is within the scope of the present invention except as the claims might expressly exclude.

The gearing and distance of advancement of the lenticular plate 20 by the actuation mechanism are again calibrated for rhythmic, realistically-cadenced, and apparently continuous animation. Again taking a crank system 30 as a non-limiting actuation mechanism and in view of this inventor's determination that the average user will rotate the crank system 30 on the viewing device 16 at the rate of approximately one and one-half (1.5) rotations per second, the viewing device 16 is geared, and the lenticular plate 20 and the coded image member 12 are calibrated, to cause this natural cranking motion to advance the platen 28 in relation to the cover structure 25 and the lenticular plate 20 at such a rate of speed that three repeating cycles are presented to the eye per second when the crank system 30 is operated at 1.5 rotations per second.

Where the crank system 30 of the viewing device 16 incorporates two gears 40 and 42 as shown, for example, in FIG. 21 retained to underlie a cross plate 46 that is disposed adjacent to the bottom of the viewing device 16 and that holds the handle 32, the primary gear 40 is again coaxial with and directly driven by the handle 32. The primary gear 40 includes ten (10) teeth and meshes with a larger, secondary gear 42 that has fifty (50) teeth for a 1/5^{th} gear ratio. A precisely offset actuation member 48 is fixed to rotate with the secondary gear 42 and to engage a snugly-fitted laterally communicating aperture 50, such as a slot, that is fixed to move with the carriage structure 62, such as but not necessarily limited to by being formed directly therein or by being retained by a member fixed thereto.

The precise offset of the actuation member 48 is such that, when rotated, the actuation member 48 will move the carriage structure 62, the platen 28, and any coded image member or members 12 retained thereby the distance of a given whole number of lenticles, such as five, and thus that given number of animation cycles in one direction for half of the revolution of the actuation member 48. As the user continues to crank and the actuation member 48 continues to rotate, the actuation member 48 reaches its apex and reverses the sliding direction of the carriage structure 62 relative to the remainder of the base structure 22, and the actuation member 48 returns the platen 28 and the carriage structure 62 to the starting position. Movement at this desired rate produces realistically-cadence animation. Hand-cranking rate of 1.5 (one and a half) rotations per second will cause the viewing device 16 to display animation at the ideal rate of three (3) cycles per second.

The viewing device 16 provides plural mechanisms to ensure accurate registration and positioning of the coded images 14 and the lenticular plate 20. Again, the platen 28 is positioned so that, when the lenticular plate 20 is closed upon the platen 28 and the coded image member 12 as part of the cover structure 25, the back of the lenticular plate 20 will rest fully and gently upon the surface of the coded image member 12, thus retaining the lenses of the lenticular plate 20 at the exact correct focal length from the coded image 14. The alignment formations 24 and 26 cooperate to place the coded image member 12 in a known, aligned disposition.

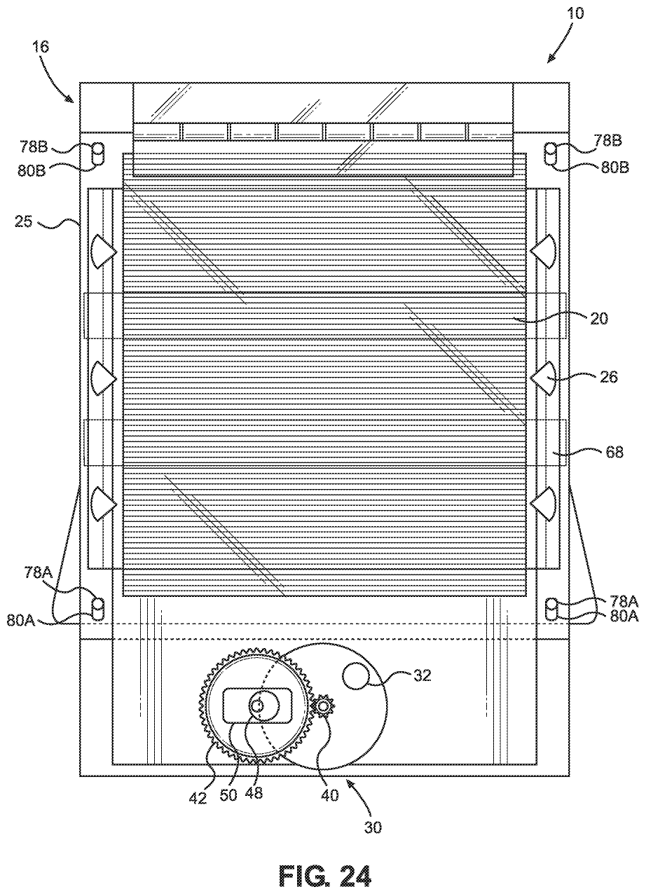

Accurate alignment and clear animation are further facilitated by a multi-peg registration system to promote aligned registration between the cover structure 25 and the base platform 22. As best seen perhaps in the depictions of FIGS. 24 and 25, precise alignment and registration and resistance to shifting are provided by four pairs of alignment pegs 78A and 78B and alignment holes 80A and 80B respectively disposed in alignment with four corners of the cover structure 25. More particularly, an upper alignment peg and hole pair 78B and 80B is disposed in alignment with each upper corner of the cover structure 25, and a lower alignment peg and hole pair 78A and 80A is disposed in alignment with each lower corner of the cover structure 25. To each of the left and right sides of the cover structure 25, one alignment peg 78A projects from the base structure 22 and one alignment peg 78B projects from the cover structure 25. Correspondingly, to each of the left and right sides of the cover structure 25, one alignment hole 80A is disposed in the cover structure 25 and one alignment hole 80B is disposed in the base structure 22. Stated alternatively, two alignment pegs 78A to the lower end of the cover structure 25 protrude upwardly from the base structure 22, and two alignment pegs 78B to the other, upper end of the cover structure 25 protrude downwardly from the cover structure 25. The alignment holes 80A and 80B are oppositely disposed in correspondence.

The alignment holes 80A and 80B are oblong or elongated in the longitudinal direction orthogonal to a pivot axis of the hinge 55 so that the holes 80A and 80B may be considered slots 80A and 80B. As such, the alignment pegs 78A and 78B can be received therein during a pivoting closed of the cover structure 25. The alignment pegs 78A and 78B and the alignment holes 80A and 80B are positioned so that the pegs 78A and 78B are closely received adjacent to the same ends of the slot holes 80A and 80B, in this example proximal to the hinge structure 55, with it being recognized that the pegs 78A and 78B could alternatively be disposed to be closely received adjacent to the ends of the slots 80A and 80B distal to the hinge structure 55. Under this configuration, as FIGS. 24 and 25 show most clearly, the cover structure 25 is locked at all four corners against displacement or misalignment relative to the base structure 22. Shifting upwardly toward the hinge structure 55 is prevented by contact of the upper pegs 78B with the ends of the slots 80B, and shifting downwardly away from the hinge structure 55 is prevented by contact of the lower pegs 78A with the ends of the slots 80A.

The alignment and registration system so disclosed overcomes any lack of precision that might derive from, for instance, play or looseness in the hinge structure 55 or in other aspects of the viewing device 16. It will be understood that the alignment and registration system provided by the alignment pegs 78A and 78B and alignment holes 80A and 80B is readily applicable not only to embodiments of the invention where the carriage structure 62 and platen 28 are reciprocated but also to embodiments of the invention where the lenticular plate 20 is reciprocated to produce animation.

The cover structure 25 is configured to maintain the lenticular plate 20 in a plane parallel to and above the plane of the platen 28. As such, as seen in FIGS. 25 and 26, upper and lower support posts 74 and 76 support the frame of the cover structure 25. As in FIG. 25, the support posts 74 and 76 can project from the frame of the cover structure 25 so that the alignment pegs 78A and 78B and the alignment holes 80A and 80B can be disposed projecting from and into a base plate of the base structure 22. Alternatively and in a manner that would create a lighter cover structure 25, the support posts 74 and 76 can project from the base plate of the base structure 22 so that the alignment pegs 78A and 78B and the alignment holes 80A and 80B can be disposed projecting from and into the frame of the cover structure 25.

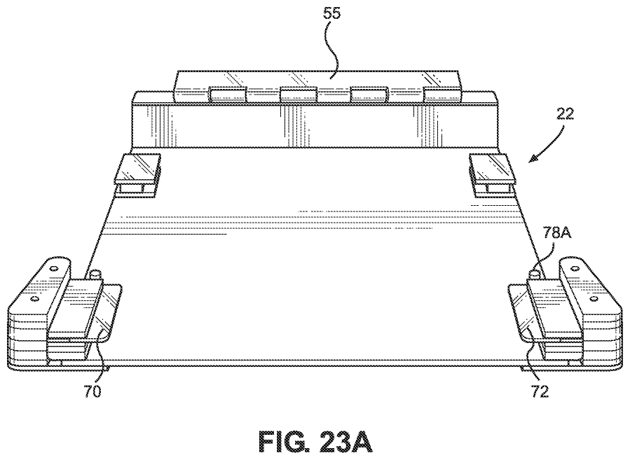

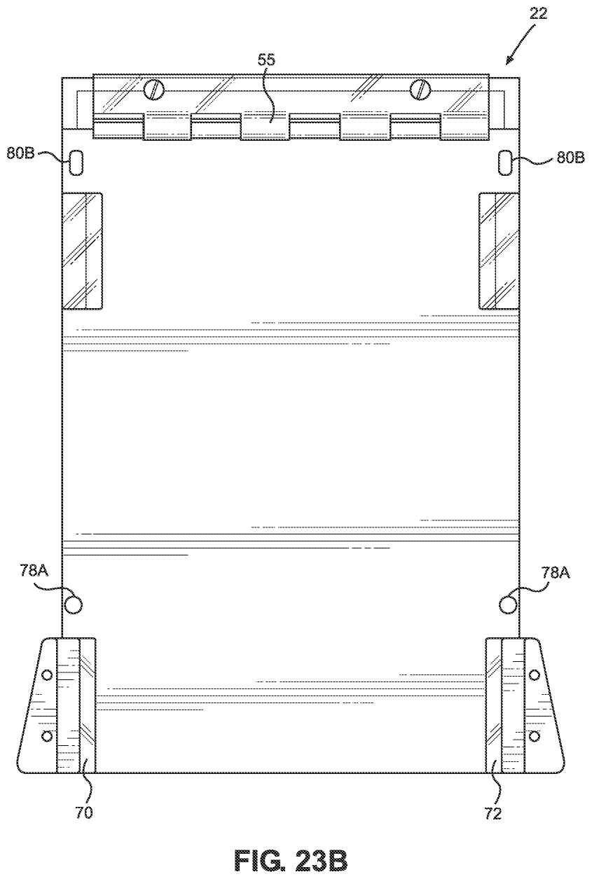

With more particular reference to FIGS. 21 through 23B, the carriage structure 62 can be seen to be slidably received by the base structure 22 by accurately positioned left and right lateral engagement structures 70 and 72. More particularly, the base structure 22 has lateral edge guide channels or ridges 70 and 72 that receive and slidably engage the lateral edges of the carriage structure 62. As FIGS. 23A and 23B show, for instance, the guide channels or ridges 70 and 72 need not communicate over the complete length of the sides of the carriage structure 62. For instance, to reduce friction between the edges of the carriage structure 62 and the inside of the channels or ridges 70 and 72 during sliding, plural, such as four, guide channel or ridge portions 70 and 72 can be employed, such as with two channel portions 70 on the left and two channel portions 72 on the right positioned toward the top and bottom ends of the base structure 22 respectively. In the depicted embodiment, each guide channel 70 and 72 comprises an edge guide that provides a lateral surface to be disposed outboard of the carriage structure 62 and an inwardly extending section that overlies a portion of the carriage structure 62 thereby to sandwich the carriage structure 62 between the inwardly extending section and the facing surface of the base structure 22. The opposed inside surfaces of the guide channels, ridges, or other guide formations 70 and 72 are disposed to engage the carriage structure 62 closely to prevent unintended lateral movement but to permit unhindered sliding of the carriage structure 62 during actuation of the crank system 30 or other actuation mechanism.

Again noting that it is preferable to view the animation of coded images straight on or at least within approximately 45 degrees to either side of straight-on, a leg structure 52 is retained by the lower side of the base structure 22 to angle the viewing device 16 toward the user, such as at 30 degrees from horizontal. Here, the leg structure 52 is pivotally engaged with the base structure 22, but other configurations are possible and within the scope of the invention.

It will be understood that terms of orientation referenced herein merely operate to provide a complete understanding of the disclosed animation reveal coloring toy and puzzle device but do not limit the invention in any respect. Other nomenclature and conventions may be used without limitation of the teachings herein. Furthermore, the various components disclosed herein are merely illustrative and are not limiting of the invention. For example, except as expressly limited by the claims, each of the components discussed herein may include subcomponents that collectively provide for the structure and function of the disclosed component. Furthermore, one or more components, sometimes referred to as members or otherwise herein, could be combined as a unitary structure while still corresponding to the disclosed components. Additional components that provide additional functions, or enhancements to those introduced herein, may be included. For example, additional components and materials, combinations of components or materials, and perhaps the omission of components or materials may be used to create embodiments that are nonetheless within the scope of the teachings herein.

When introducing elements of the present invention or embodiments thereof, the articles “a,” “an,” and “the” are intended to mean that there are one or more of the elements. The terms “comprising,” “including,” and “having” are intended to be inclusive such that there may be additional elements other than the listed elements. As used herein, terms such as “example” or “exemplary” are not intended to imply a superlative example. Rather, “exemplary” refers to an embodiment that is one of many possible embodiments.

With certain details and embodiments of the present invention for an animation reveal coloring toy and puzzle device disclosed, it will be appreciated by one skilled in the art that numerous changes and additions could be made thereto without deviating from the spirit or scope of the invention. This is particularly true when one bears in mind that the presently preferred embodiments merely exemplify the broader invention revealed herein. Accordingly, it will be clear that those with major features of the invention in mind could craft embodiments that incorporate those major features while not incorporating all of the features included in the preferred embodiments.

Therefore, the following claims shall define the scope of protection to be afforded to the invention. Those claims shall be deemed to include equivalent constructions insofar as they do not depart from the spirit and scope of the invention. It must be further noted that a plurality of the following claims may express, or be interpreted to express, certain elements as means for performing a specific function, at times without the recital of structure or material. As the law demands, any such claims shall be construed to cover not only the corresponding structure and material expressly described in this specification but also all legally-cognizable equivalents thereof.

What is claimed as deserving of Letters Patent is:

1. A lenticular animation system for animating a coded image of a coded image member, the animation system comprising: a viewing device comprising a base structure with a platen for supporting the coded image member, a cover structure pivotally coupled to the base structure with a closed position atop the base structure and an open position, a lenticular plate retained by the cover structure to span and to define a viewing area within the cover structure, and an actuation mechanism operative to produce relative movement between the platen and the lenticular plate whereby animation of a coded image of a coded image member supported by the platen can be perceived within the viewing area when the actuation mechanism produces relative movement between the platen and the lenticular plate.

2. The lenticular animation system of claim 1 further comprising a coded image member with a coded image disposed thereon.

3. The lenticular animation system of claim 2 further comprising alignment formations comprising protuberances retained to be disposed adjacent to left and right lateral edges of the platen and alignment formations disposed in the coded image member, wherein the alignment formations of the coded image member comprise notches for receiving the protuberances, wherein the lenticular plate has left and right lateral edges, and wherein the alignment formations comprising protuberances are disposed laterally outside of the left and right lateral edges of the lenticular plate.

4. The lenticular animation system of claim 2 further comprising alignment formations retained adjacent to opposed edges of the platen and alignment formations disposed in the coded image member wherein the alignment formations retained adjacent to opposed edges of the platen and the alignment formations of the coded image member are disposed in correspondence for engagement between the alignment formations when the coded image member is supported by the platen.

5. The lenticular animation system of claim 4 wherein the platen has a platen surface disposed in a plane and wherein the alignment formations retained adjacent to opposed edges of the platen comprise protuberances that project beyond the plane of the platen surface.

6. The lenticular animation system of claim 5 wherein the lenticular plate has opposed left and right lateral edges and wherein the alignment formations retained adjacent to opposed edges of the platen are aligned to be laterally outside of the left and right lateral edges of the lenticular plate.

7. The lenticular animation system of claim 6 wherein the cover structure comprises a framework with left and right frame sections that are disposed atop the lenticular plate when the cover structure is in a closed position, wherein the left and right frame sections have portions that project laterally beyond the lateral edges of the lenticular plate, wherein the alignment formations retained adjacent to lateral edges of the platen are aligned with the portions of the left and right frame sections that project laterally beyond the lateral edges of the lenticular plate.

8. The lenticular animation system of claim 7 wherein the cover structure is pivotally coupled to the base structure by a hinge, wherein the alignment formations retained adjacent to opposed edges of the platen have upper edges proximal to the hinge, and wherein the upper edges of the alignment formations are slanted to an acute angle toward the hinge.

9. The lenticular animation system of claim 1 wherein the cover structure is pivotally coupled to the base structure by a hinge and further comprising an alignment and registration combination for aligning and registering the cover structure relative to the base structure wherein the alignment and registration combination comprises at least one alignment projection that projects from one of the cover structure and the base structure in combination with at least one receiving formation for receiving the at least one alignment projection wherein the receiving formation is disposed in the other of the cover structure and the base structure.

10. The lenticular animation system of claim 9 wherein the at least one alignment projection comprises a post and wherein the at least one receiving formation has a positive engagement mechanism for receiving and positively engaging the at least one alignment projection.

11. The lenticular animation system of claim 10 wherein the at least one alignment projection comprises a post that terminates in a bulbous end portion and wherein the positive engagement mechanism of the at least one receiving formation comprises a spring-loaded, snap-fit, or spring-loaded and snap-fit positive engagement mechanism.

12. The lenticular animation system of claim 1 wherein the cover structure is pivotally coupled to the base structure by a hinge to pivot about a hinge axis and further comprising an alignment and registration combination for aligning and registering the cover structure relative to the base structure, wherein the alignment and registration combination comprises a first alignment pair spaced from a second alignment pair, wherein each alignment pair comprises an alignment peg and an alignment hole for receiving the alignment peg, wherein the alignment peg of the first alignment pair projects from the base structure and the alignment hole of the first alignment pair is disposed in the cover structure, and wherein the alignment peg of the second alignment pair projects from the cover structure and the alignment hole of the second alignment pair is disposed in the base structure.

13. The lenticular animation system of claim 12 wherein the alignment hole of each alignment pair is broader along a receiving direction orthogonal to the hinge axis than a thickness of the alignment peg of the alignment pair along the receiving direction, wherein each alignment hole has a first end proximal to the hinge and a second end distal to the hinge, wherein the alignment pegs of the first and second alignment pairs are received in immediate proximity to the same of the first or second ends of the respective alignment holes whereby, when the cover structure is pivoted to a closed position, the cover structure is locked against displacement relative to the base structure by contact of the alignment pegs with the ends of the respective alignment holes.

14. The lenticular animation system of claim 12 wherein the alignment and registration combination further comprises third and fourth alignment pairs, each alignment pair comprising an alignment peg and an alignment hole for receiving the alignment peg, wherein the alignment peg of the third alignment pair projects from the base structure and the alignment hole of the third alignment pair is disposed in the cover structure, wherein the alignment peg of the fourth alignment pair projects from the cover structure and the alignment hole of the fourth alignment pair is disposed in the base structure, wherein the alignment hole of each of the third and fourth alignment pairs is broader along a receiving direction orthogonal to the hinge axis than a thickness of the alignment peg of the alignment pair along the receiving direction, wherein each alignment hole has a first end proximal to the hinge and a second end distal to the hinge, wherein the alignment pegs of the third and fourth alignment pairs are received in immediate proximity to the same of the first or second ends of the respective alignment holes whereby, when the cover structure is pivoted to a closed position, the cover structure is locked against displacement relative to the base structure by engagement of the alignment pegs with the ends of the respective alignment holes.

15. The lenticular animation system of claim 14 wherein the first, second, third, and fourth alignment pairs are disposed in a rectangular configuration.

16. The lenticular animation system of claim 1 wherein the lenticular plate has laterally communicating lenticles, wherein the lenticles are disposed at a lens pitch comprising the size of one lenticle, and wherein the actuation mechanism comprises a manually-operated actuation mechanism operative to produce longitudinal relative reciprocation between the platen and the lenticular plate.

17. The lenticular animation system of claim 16 wherein the lenticular plate is retained to slide longitudinally relative to the cover structure, wherein the actuation mechanism is operative to reciprocate the lenticular plate longitudinally, wherein the lenticular plate has left and right lateral edges, and further comprising left and right lateral edge guides retained by the cover structure for guiding and maintaining alignment of the lenticular plate during reciprocation of the lenticular plate in relation to the cover structure.

18. The lenticular animation system of claim 17 wherein each of the left and right lateral edge guides comprises a lateral surface disposed lateral to the respective lateral edge of the lenticular plate and an inwardly extending section that overlies the lenticular plate thereby to prevent unintended lateral movement of the lenticular plate but to permit longitudinal reciprocation of the lenticular plate.

19. The lenticular animation system of claim 16 wherein the platen is retained by a carriage structure to slide longitudinally relative to the base structure and wherein the actuation mechanism is operative to reciprocate the carriage structure and the platen longitudinally.

20. The lenticular animation system of claim 19 further comprising left and right lateral edge guides retained by the base structure for guiding and maintaining alignment of the carriage structure and the platen during reciprocation of the carriage structure relative to the base structure.

21. The lenticular animation system of claim 16 wherein the actuation mechanism is operative to produce longitudinal relative reciprocation between the platen and the lenticular plate over a range of reciprocation of a distance equal to a whole multiple of lens pitches.

22. The lenticular animation system of claim 16 wherein the manually-operated actuation mechanism comprises a crank system with a rotatable hand crank for being rotated by a user and a gearing system for inducing longitudinal relative reciprocation between the platen and the lenticular plate based on a rotation of the hand crank.

23. The lenticular animation system of claim 22 wherein the gearing system and the lens pitch of the lenticular plate are calibrated to move the lenticular plate at approximately three lenticles per second when the hand crank is rotated at 1.5 rotations per second whereby an instinctive rotation of the hand crank at 1.5 rotations per second will ergonomically convert to a movement of the lenticular plate at approximately three lenticles per second to produce naturally-cadenced animation.

24. The lenticular animation system of claim 22 wherein the gearing system comprises a primary gear coaxial with and driven by the hand crank, a secondary gear driven by the primary gear, and an offset actuation member rotated with the secondary gear.

25. The lenticular animation system of claim 24 wherein the primary gear and the secondary gear have an approximately 1/5^{th} gear ratio.

26. The lenticular animation system of claim 1 further comprising a coded image member with a coded image thereon, wherein the coded image is formed by a plurality of interlaced strips of plural images, and wherein at least a portion of the coded image comprises a user-completed portion for being colored by a user whereby a user can participate in the creation of coded images for coded image animation by completing the user-completed portion of the coded image for animation by movement of the lenticular plate.

27. The lenticular animation system of claim 26 wherein the coded image member further has a non-coded image thereon and wherein the coded image and the non-coded image relate to a unified theme whereby the theme of the coded image can be perceived by reference to the theme of the non-coded image thereby further enhancing the ability of a user to participate in the creation of coded images.

28. The lenticular animation system of claim 26 wherein the plurality of interlaced strips of plural images of the coded image are outlined except where adjacent interlaced strips of images are in contact and wherein a continuous, user-completed portion is presented where adjacent interlaced strips of images are in contact.

29. The lenticular animation system of claim 1 further comprising a coded image member with a coded image thereon, wherein the coded image is formed by a plurality of interlaced strips of plural images, and further comprising a removable obscuring overlay disposed atop the coded image whereby a user can participate in a revelation of the coded image by removing the obscuring overlay to expose the coded image for animation by relative movement between the platen and the lenticular plate.

30. The lenticular animation system of claim 1 further comprising a coded image member with a coded image thereon and wherein the coded image is exposable on exposure of the coded image to a reagent whereby a user can participate in a revelation of the coded image for animation by relative movement between the platen and the lenticular plate by application of the reagent.

31. The lenticular animation system of claim 1 further comprising a coded image member with a coded image thereon wherein the coded image member is formed as a jigsaw puzzle of puzzle pieces with the coded image spanning plural puzzle pieces whereby a user can participate in a revelation of the coded image by assembling the puzzle pieces to assemble the coded image member for animation by relative movement between the platen and the lenticular plate.

32. The lenticular animation system of claim 31 further comprising a puzzle platen with an indentation for receiving and retaining the puzzle pieces whereby the puzzle platen with the puzzle pieces can be disposed on the platen of the base structure.

33. The lenticular animation system of claim 32 wherein the puzzle pieces have a thickness marginally greater than a depth of the indentation of the puzzle platen whereby the lenticular plate can be disposed in contact with the puzzle pieces when the cover structure is closed over the base structure.

34. The lenticular animation system of claim 32 further comprising alignment formations in the puzzle platen and alignment formations retained to project from adjacent to the platen wherein the alignment formations retained to project from adjacent to the platen and the alignment formations of the puzzle platen are disposed in correspondence for engagement between the alignment formations when the puzzle platen is supported by the platen.

35. A lenticular animation kit for animating a coded image of a coded image member, the animation kit comprising:
a coded image member with a coded image disposed thereon wherein the coded image is formed by a plurality of interlaced strips of plural images;
a viewing device comprising:
a base structure with a platen with a platen surface and left and right lateral edges, the platen surface for supporting the coded image member;
a cover structure pivotally coupled to the base structure by a hinge wherein the cover structure has a closed position atop the base structure and an open position;
a lenticular plate retained by the cover structure to span and to define a viewing area within the cover structure wherein the lenticular plate has left and right lateral edges and lenticles that communicate laterally between the left and right lateral edges; and
a manually-operated actuation mechanism operative to produce longitudinal, reciprocating relative movement between the platen and the lenticular plate;
alignment formations disposed adjacent to the left and right lateral edges of the platen and alignment formations disposed in the coded image member wherein the alignment formations disposed adjacent to the left and right lateral edges of the platen and the alignment formations of the coded image member are disposed in correspondence for engagement between the alignment formations when the coded image member is supported by the platen;
whereby animation of the coded image of the coded image member can be perceived within the viewing area when the actuation mechanism produces longitudinal, reciprocating relative movement between the platen and the lenticular plate when the coded image member is supported on the platen with the cover structure in the closed position.
